(19) United States
(12) Patent Application Publication
(10) Pub. No.: US 2026/0256156 A1
(43) Pub. Date: Sep. 3, 2026

(54) SYSTEMS AND METHODS FOR APPLYING TREATMENTS FOR PRESERVATION OF PERISHABLE GOODS

(71) Applicant: RLMB GROUP, LLC, Honolulu, HI (US)

(72) Inventors: Randall Craig BOWDEN, Honolulu, HI (US); Robert W. HERDEMAN, Loveland, OH (US)

(21) Appl. No.: 19/538,824

(22) Filed: Feb. 12, 2026

Related U.S. Application Data
(63) Continuation of application No. 17/762,025, filed on Sep. 18, 2020.
(63) Continuation of application No. 16/811,862, filed on Mar. 6, 2020, now abandoned.
(60) Provisional application No. 62/815,258, filed on Mar. 7, 2019.
(60) Provisional application No. 62/903,400, filed on Sep. 20, 2019.
(60) Provisional application No. 62/986,270, filed on Mar. 6, 2020.

(51) Int. Cl. A23B 2/742; A23B 2/712; B65D 81/28

(52) U.S. Cl. CPC A23B 2/742; A23B 2/712; B65D 81/28

(57) ABSTRACT

A method for treating a perishable product is provided, the method comprising: determining a desired product treatment outcome selected from sanitization, protection, preservation, or enhancement of the perishable product; after harvesting, wet or dry washing the perishable product; directly or indirectly applying a substance to the surface of the perishable product using a carrier; and packaging the perishable product. A system for treating a perishable product with a substance treatment is provided, the system comprising: one or more devices for directed substance application to a surface of the perishable products prior to final packaging of the perishable product using a carrier; and wherein the one or more devices is an electrostatically charging device or a nebulizer. Embodiments of the invention which use multiple, sequenced, and engineered applications enhance the efficacy of sanitizers and other functional substances for increasing the quality, safety, and overall shelf life of perishable products.

### CROSS-REFERENCE TO RELATED APPLICATIONS

This application is a continuation of U.S. application Ser. No. 17/762,025, filed on Sep. 18, 2020, which is a National Stage Application under 35 U.S.C. § 371 of International Application No. PCT/US2020/051591, filed on Sep. 18, 2020, which claims priority benefit from U.S. Provisional Application No. 62/903,400, filed on Sep. 20, 2019, and U.S. Provisional Application No. 62/986,270, filed on Mar. 6, 2020; and this application is a continuation of U.S. application Ser. No. 16/811,862, filed on Mar. 6, 2020, which claims priority to U.S. Provisional Application No. 62/815,258, filed on Mar. 7, 2019. The entire contents of each of the aforementioned applications is incorporated herein by reference in their entireties.

### TECHNICAL FIELD

The present invention generally relates to systems and methods for improved application of substance treatments for perishable goods. It further relates to improved methods and systems for prescribed, controlled, and efficient application of substance treatments on the surface of perishable products. More specifically, embodiments of the invention enhance the efficacy of sanitizers and other functional substances for increasing the quality, safety, and overall shelf life of perishable products through improved contact, coating and distribution of the sanitizers and functional substances on the surface of perishable product.

### BACKGROUND

Perishable products generally have a short shelf life and are susceptible to damage or spoiling prior to reaching the consumer. Perishable products may include, for example, produce, plants, fresh or frozen foods, prepared foods, agricultural products, meats, cell cultures, tissues, and other live organisms. Perishable products may need to be transported from their growing area, and may be exposed to, contaminated by, or otherwise susceptible to the effects of spoilage and pathogenic organisms. Because of the additional transport time, the perishable product may have a very short shelf life once it reaches the consumer. In order to maximize the shelf life and to reduce the susceptibility to pathogens and spoilage, many perishable products are shipped via air, significantly adding to the cost. Additionally, some perishable products may be contaminated with bacteria or other pathogens from the source, and therefore require washing and/or sanitization before reaching the consumer. For many perishable products, the sanitization must be performed without thermally processing the perishable product. Thermal processing, which includes heating, raising the temperature, or exposing the perishable product to higher temperatures, can damage sensitive tissues and raises respiration that can also have a negative impact on long term shelf life. As such, these steps are often insufficient or ineffective toward the overall objective. Bacteria and fungus are brought into cooling rooms and processing equipment from the fields by contaminated products, further increasing the risk of contamination. Additionally, excess surface moisture on perishable products can enable bacteria and fungus to grow dramatically.

Particularly, vegetables including bagged salad and lettuce products have suffered from numerous outbreaks of E. coli and other contaminants, even so-called “triple washed” vegetables. Lettuce or greens harvested in the field may be rinsed with chlorinated water. The vegetables may undergo three washes, before being spun dried, and then weighed and bagged. However, the high amount of organic matter in the wash system can overwhelm the efficacy of the sanitizer. Ineffective sanitization (that is, the reduction and/or elimination of harmful microbial organisms or contaminated product) has led to sickness and even death in rare circumstances.

Cut flowers are stored in a cold room after harvesting, but are susceptible to mold prior to reaching the end consumer. As a result, flowers must be transported by air to diminish product loss, which increases costs significantly. Therefore, there is a need to treat flowers to prevent mold, while still maintaining the proper hydration of cut flowers that will increase the overall quality of the product and also allow for longer but less costly transport.

In the case of meats, the outside surface of meats may become contaminated with bacteria after harvesting, while the interior remains clean. Chemicals may be used to spray the outside surface of the meat to reduce the presence of bacteria. However, particularly in the case of ground or cut meat, the clean interior may become exposed to the contaminated exterior, which is then incorporated into the final product. There is a need to process meat in a clean manner using less chemicals, and to more effectively prevent or eliminate bacterial contamination.

The area of the fruit, for example tomatoes, that was attached to the stem (the pick scar) is a region that becomes especially susceptible to the establishment of spoilage organisms and potential contamination by human pathogens. Furthermore, fruit may become bruised or damaged which also creates areas especially susceptible to spoilage and microbial contamination. Other fruits, such as berries, are extremely sensitive to rapid mold growth, where any excess moisture or surface water present, even if a sanitizer is used, will result in reduced shelf life and accelerated spoilage.

As described above, current treatments rely on a single method or substance to provide the needed benefits and are found to be insufficient to achieve the intended result. Therefore, there is a need to treat perishable products using methods and systems that can deliver substantially improved results. This begins with the use of various (not just one) treatments or substances to extend shelf life, to prevent, reduce and/or eliminate growth of spoilage and pathogenic (microbial) organisms on the perishable products, and to improve the overall quality of the perishable products. Further, there is a need to ensure that the substance treatment is applied to the perishable product uniformly, contacts and/or sufficiently coats the surface of the perishable product and that does not overly saturate the product with excess moisture. Still further, there is a need to apply the substance treatment to the perishable product in an open industrial environment or in an open packing line, in a manner that is safe to nearby workers and to the environment. Still further, there is a need to incorporate the above substance treatment to existing processing lines at various points of the process in a cost effective manner.

### SUMMARY

A method for treating a perishable product is provided, the method comprising wet or dry washing, sanitizing, cleansing or cleaning the perishable product; and directly applying a functional treatment to a surface of the perishable product after harvesting using a carrier.

A system for treating a perishable product with a substance treatment is provided comprising one or more devices for directed substance application to a surface of the perishable product prior to or during filling of final packaging of the perishable product using a carrier; a sensor for evaluating the surface of the perishable product; and a controller for controlling the directed substance application based on feedback from the sensor.

A punnet for cooling, treating, and packaging a perishable product is provided comprising a first half having a perishable product receiving portion; and a second half fitting over the product receiving portion, wherein the second half removably engages with the first half thereby enclosing the product receiving portion, the punnet having a top flange where film or lidding material is sealed, snap sealed, or affixed to enclose the punnet when the second half is engaged with the first half.

A method of treating a perishable product is provided comprising incorporating a functional ingredient onto the surface of a packaging material; and packing the perishable product into the packaging material; wherein the functional ingredient transfers from the packaging material to the surface of the perishable product or wherein the functional ingredient does not transfer from the packaging material to the surface of the perishable product but provides a prescribed change in the environment surrounding the product.

A method for treating a perishable product is provided, the method comprising: determining a desired product treatment outcome selected from sanitization, protection, preservation, or enhancement of the perishable product; directly applying a substance to the surface of the perishable product after harvesting using a carrier; wet or dry washing, sanitizing, cleansing or cleaning the perishable product; and packaging the perishable product.

A method for treating a perishable product is provided, the method comprising: determining a desired product treatment outcome selected from sanitization, protection, preservation, or enhancement of the product; directly applying a first substance to the surface of the perishable product after harvesting using a first carrier; and directly applying a second substance to the surface of the perishable product prior to final packaging of the perishable product using a second carrier; wherein the second substances enhances the efficacy of the first substance.

A system for treating a perishable product with a substance treatment is provided, the system comprising: one or more devices for directed substance application to a surface of the perishable products prior to final packaging of the perishable product using a carrier; and wherein the one or more devices is an electrostatically charging device or a nebulizer.

A system for treating a perishable product with a substance treatment is provided, the system comprising: one or more devices for directed substance application to a surface of the perishable product prior to final packaging of the perishable product using a carrier; a sensor for evaluating the surface of the perishable product; and a controller for controlling the directed substance application based on feedback from the sensor.

A method for treating a perishable product with a substance is provided, the method comprising: determining a desired product treatment outcome selected from sanitization, protection, preservation, or enhancement of the perishable product; evaluating the surface of the perishable product; and directly applying a substance to the surface of the perishable product after harvesting using a carrier based on the evaluated surface of the perishable product.

A method for treating a perishable product with a substance is provided, the method comprising: determining a desired product treatment outcome selected from sanitization, protection, preservation, or enhancement of the product; wet or dry washing the perishable product; directly applying a substance to the surface of the perishable product after harvesting using a carrier; and applying a durable coating to the surface of the treated perishable product.

A method for treating a perishable product with a substance is provided, the method comprising: determining a desired product treatment outcome selected from sanitization, protection, preservation, or enhancement of the perishable product; placing a perishable product in a 360 degree pass through zone, apparatus, tunnel, chamber, or a ventilated space; and directly applying a substance to the surface of the perishable product using a directed gas carrier in the 360 degree pass through zone, apparatus, tunnel, chamber, or ventilated space.

A method for treating a perishable product with a substance is provided, the method comprising: determining a desired product treatment outcome selected from sanitization, protection, preservation, or enhancement of the perishable product; evaluating a surface of the perishable product; determining a surface area of the perishable product; selecting the appropriate substance to treat the surface of the perishable product based on the surface evaluation; selecting the optimal volume of substance to be applied to the surface of the perishable product based on the substance and the surface area of the perishable product; selecting the optimal treatment time of the surface of the perishable product; determine the optimal carrier for applying the substance; determining the optimal distance from the surface for application of the substance; determining the optimal direct application method including continuous, pulsed, sequenced, intermittent flow; directly applying the optimal-prescribed volume of the substance to the surface of the perishable product for the optimal-prescribed treatment time at the optimal or prescribed distance from the surface; measuring the amount of the substance that is present on the surface of the perishable product; reapplying the substance if the amount of the substance that is present on the surface of the perishable product is below a predetermined value; measuring the effect of the substance that is present on the surface of the perishable product; and reapplying the substance if the effect of the substance that is present on the surface of the perishable product is below a predetermined value.

A method for treating a perishable product with a substance is provided, the method comprising: determining a desired product treatment outcome selected from sanitization, protection, preservation, or enhancement of the perishable product; determining or applying an electrostatic charge to the perishable product; determining or applying an opposite electrostatic charge to the substance; and directly applying the appropriate or prescribed electrostatically charged substance to a surface of the perishable product using a carrier.

A method of treating a perishable product with an electrostatically charged substance is provided, the method comprising: detecting an area on the surface of the perishable product prone to decay; determining or applying an electrostatic charge to the perishable product; applying an opposite electrostatic charge to a substance; directly applying the substance to the area on the surface of the perishable product prone to decay using a carrier.

An apparatus for determining and/or applying an electrostatically charged substance to a perishable product is provided, the apparatus comprising: a sensor for determining an electrostatic charge and or an electrostatic mechanism for applying an electrostatic charge to the perishable product, a tunnel, a conveyor or apparatus for receiving the perishable product and passing through the treatment zone or tunnel, and a second electrostatic spray mechanism for applying the electrostatically charged substance to the perishable product.

A punnet for pre-treating, cooling, treating, and/or packaging a perishable product, the punnet comprising: a first half having a perishable product receiving portion; and a second half fitting over the product receiving portion; wherein the second half removably engages with the first half thereby enclosing the product receiving portion, the punnet having a top flange where film is sealed to enclose the punnet when the second half is engaged with the first half.

A method for treating a perishable product with an electrostatic substance is provided, the method comprising: determining and/or establishing a positive electrostatic charge to the perishable product; applying an opposite negative electrostatic charge to at least one substance; and spraying or applying the perishable product with the at least one substance using a carrier. Alternatively, an electrostatically charged surface treatment can be applied that coats and adheres to the product and a second oppositely charged substance can be applied to the product.

An apparatus for applying an electrostatically charged substance to a perishable product is provided, the apparatus comprising: an electrostatic mechanism for applying an electrostatic charge to the perishable product or a means to ground the product, a tunnel, a conveyor for receiving the perishable product and passing through the tunnel, and a second electrostatic spray mechanism for applying the electrostatically charged substance to the perishable product.

A system to apply effective substances to perishable products at points in their general process and using improved methods for efficient application to increase their quality, safety, and overall shelf life is provided. The system includes determination of the substance treatment useful at the point in the product's general process, and then using the appropriate method and apparatus to efficiently obtain prescribed, targeted and sufficient coverage of the product with the substance treatment.

Methods for treating a perishable product are provided, the methods comprising: creating substance treatments formulated for food safety, quality and/or shelf life improvement; inserting the substance treatments into advantageous steps of the general process for the product; using a carrier to enhance the spray, vaporized, atomized, or solid delivery of the substance treatment to the product; and applying opposite electrostatic charges to the substance treatment and perishable product to further enhance targeted and sufficient coverage of the product surface.

Apparatuses for applying the substance to a perishable product within the steps of its general process are provided, the apparatuses comprising: devices to deliver the substance treatment; devices to carry the substance treatment; devices to determine the presence, type and level of an electrostatic charge on a product or substance, devices such as an electrostatic spray bar for applying an electrostatic charge to the perishable product; devices to create an opposite electrostatic charge to the substance treatment; devices to determine a product is available for treatment; devices identifying a part of a product for substance treatment; devices to provide UV light or luminescence or devices with sensors to detect products or parts for treatment or to determine sufficient treatment coverage, or to activate components of the substance treatment; controllers and/or programs directing the functions of the various devices, sensors and apparatuses.

### BRIEF DESCRIPTION OF THE DRAWINGS

The features and advantages of the invention will be apparent from the following drawings wherein like reference numbers generally indicate identical, functionally similar, and/or structurally similar elements.

FIGS. 1A and 1B are flowcharts of certain functionality implemented by various embodiments of the present disclosure.

FIG. 2 is a flowchart of certain functionality implemented by another embodiment of the present disclosure.

FIG. 3 is a flowchart of certain functionality implemented by another embodiment of the present disclosure.

FIG. 4 is a schematic block diagram of an embodiment of the present disclosure.

FIG. 5 is a schematic block diagram of another embodiment of the present disclosure.

FIG. 6 is a flowchart of certain treatment locations according to various embodiments of the present disclosure.

FIG. 7 is a flowchart of treatment in a greenhouse according to an embodiment of the present disclosure.

FIG. 8 is a flowchart of treatment postharvest according to an embodiment of the present disclosure.

FIG. 9 is a flowchart of treatment postharvest according to another embodiment of the present disclosure.

FIG. 10 is a flowchart of treatment in a cooling room according to an embodiment of the present disclosure.

FIG. 11 is a flowchart of treatment in washing operation according to an embodiment of the present disclosure.

FIG. 12 is a flowchart of treatment in transfer to packing according to an embodiment of the present disclosure.

FIG. 13 is a flowchart of treatment in transfer to packing using a vision system according to another embodiment of the present disclosure.

FIG. 14 is a flowchart of inspection and treatment according to an embodiment of the present disclosure.

FIG. 15 is a flowchart of treatment during packing according to an embodiment of the present disclosure.

FIG. 16 is a flowchart of certain treatment locations according to various embodiments of the present disclosure.

FIG. 17 is a schematic of a treatment of a floral product according to various embodiments of the present disclosure.

FIGS. 18A and 18B are schematics of a wrapping or packing of a floral product according to various embodiments of the present disclosure.

FIG. 19 shows a package according to an embodiment of the present disclosure.

FIG. 20 shows a package according to an embodiment of the present disclosure.

FIG. 21 shows a package according to an embodiment of the present disclosure.

FIGS. 22A to 22E show an example of a package with a folded insert according to an embodiment of the present disclosure.

FIG. 23A shows an example of a package with a label within the lid according to an embodiment of the present disclosure.

FIG. 23B shows an example of a package with a label within the base according to an embodiment of the present disclosure.

FIGS. 24A to 24C show an example of a package with a label within the lid and base according to an embodiment of the present disclosure.

FIG. 25 shows an example of a package with a label within the lid and base according to an embodiment of the present disclosure.

FIG. 26 is an embodiment of a flow wrap machine incorporating substance treatment.

FIG. 27 is an embodiment of a form fill machine incorporating substance treatment.

### DETAILED DESCRIPTION

Embodiments of the invention are discussed in detail below. In describing embodiments, specific terminology is employed for the sake of clarity. A person skilled in the relevant art will recognize that other equivalent parts can be employed and other methods developed without departing from the spirit and scope of the invention.

Aspects of the invention relate to an overall systems approach for determining the best and appropriate substances and treatments for each perishable product. According to embodiments, the system to define process needs may include determining points in the process where substance treatments can be inserted, determining optimal methods for substance addition, providing other enhancements such as reduced dehydration and cross-contamination, and combinations thereof. According to embodiments, the system may apply predictive artificial intelligence by using data from key sources, histories, and sensors for gathering and depicting conditions such as environmental (temperature, humidity, rain, wind, sun, fog), airborne fungal spore counts, decay levels quality assessments, or pest counts, soil, product/water/crop conditions (fungal, bacteria, virus, spoilage or pathogenic organisms, contamination, mineral or other deficiency), soil amendments, pesticide and herbicide treatments, irrigation and wash water, local or regional risk factors. According to embodiments, the system may apply machine learning for proper and continuous improvement of the treatment delivery.

Aspects of the invention include determining and integrating process management and controls. According to embodiments, process management and controls may include options for automatic or manual over-ride, integrating computer/PLU software-based processes, local and remote control, sensors used to determine location and aspects of the product, environment, and direct treatment conditions and achieve target results (including individual or combined sensor technologies such as LiDAR, radar, and vision technologies for control of products and treatments, and environmental sensors for microorganism detection and measurement), and feedback loops, and use of artificial intelligence/machine learning to provide continuous improvement of the process and outcomes. According to embodiments, process management and controls may include programmed cooling process with substance treatments, programmed refrigeration sanitization, programmed substance delivery, sensors to detect product for treatment, sensors to detect and measure the level of sanitizer (application and residual levels), sensors to detect and measure microorganisms, passive and active sensors for process controls, vision technology to detect and direct treatments, recording process measurements for continuous system improvements and HACCP, and combinations thereof. Aspects of the invention include development and integration of programmed substance treatments. According to embodiments, programmed substance treatments may include pre-treatment, in-process treatment, sequenced treatment, final treatment, and combinations thereof. Aspects of the invention include assessing the product and process to determine a preferred substance delivery. According to embodiments, methods of preferred substance delivery may include dry delivery (electrostatic charged and/or directed air/gas flow), wet delivery (spray, electrostatic charged, nebulized/atomized), smart and robotic assisted spray, and substance delivery using directed air pressure or industrial gas, recirculating air, low volume liquid (water, ethanol, isopropyl alcohol and the like), water, ionized water, and ionized air, and combinations thereof. According to embodiments, methods of preferred substance delivery include continuous, pulsed, sequenced, and intermittent flow. Aspects of the invention include developing and implementing effective and synergistic combinations of functional ingredients. According to embodiments, preferred combinations of functional ingredients may include anti-microbial sanitizing, surface adhesion, surface barrier film, humectant, preservative, organoleptic, health, plant nutrition, surfactants, buffering agents, emulsifiers, direct product application of electrostatic+UV light treatments, MAP N₂+ ozone, and combinations thereof. According to embodiments, substances to reduce microorganisms may include ozone, sanitizers, essential oils, or combinations thereof.

Embodiments of the disclosure relate to applying a substance treatment to a perishable product at various points during processing from harvest to final packaging and transport. According to embodiments, the applying can be coating the perishable product and/or contacting a surface of the perishable product (e.g., deposited on the surface, either as a gas or liquid). According to embodiments, the directed application is by electrostatic spray. According to embodiments, the directed application is by a nebulizer. According to embodiments, the directed application is by fogging. According to embodiments, the directed application is electrical energy, electrical pulses, ultrasound, UV light, electromagnetic treatment and the like. According to embodiments, the directed application achieves sufficient product coverage to efficiently achieve the desired result with minimal overspray. For example, the substance treatment may be an essence compound that is very expensive, but may be efficiently applied using embodiments of this invention, thereby saving money.

According to embodiments, the substance treatment may be applied using a wet or dry delivery system. According to embodiments, the substance treatment may be delivered by electrostatic spray, nebulized, fogged, vaporized, atomized, or directed air application. According to embodiments, the substance may comprise industrial gas, liquid, or powder ingredients. According to embodiments, the substance treatment may be delivered to the surface of a product between harvesting, production, and final packing. The substance treatment according to the present invention may prevent or delay the onset of quality defects by reducing or eliminating the damaging organisms on the surface of the product. The substance treatment according to the present invention can be applied in conjunction with the harvest, or during processing. According to embodiments, substance treatment can be applied in open, partially open, or closed environments but do not require an airtight or hermetically sealed enclosure. Using the system does not need or require a modified atmosphere or controlled atmosphere enclosure, and can be applied completely open to the atmosphere or within a partially enclosed space still open to the atmosphere, such as a spray chamber, tunnel, open tube, 360 degree or partial spray ring, to direct, control or to contain the spray or substance treatment and achieve the intended outcome safely and effectively. A modified atmosphere is an airtight sealed enclosure around the perishable product to allow for injection and maintenance of industrial gases. The substance treatment according to the present invention can be combined with a modified atmosphere and in atmosphere substance treatments for additional benefits.

Embodiments of the invention relate to applying a substance treatment to a perishable product to facilitate the precise and even application of the substance treatment. According to embodiments, a predetermined amount of the substance may be applied to the surface to substantially contact or coat the surface, where some treatments will cover a predetermined amount of the targeted surface, some substance treatments will leave no residual level of surface coverage, and others may need one or more passes or progressive applications to achieve the levels required. The substance may be a sanitizer, protective coating, preservative, flavor and/or aroma enhancer, color, nutritional additive, or any other substance that may improve the shelf life, quality, safety, value, appearance, or aroma of the perishable product. According to embodiments, the substance treatment may be a surfactant or other compound to enhance the functional efficacy or contact of other treatment ingredients. According to embodiments, the substance treatment may be an essence, extract, or essential oil. According to embodiments, the substance treatment according to the present invention may provide sanitizing, anti-fungal, or flavoring directly to the product's surface. According to embodiments, the substance treatment may be a liquid surface coating using ionized water or a directed air or industrial gas surface coating. According to embodiments, the substance may include O₃, organic compounds, humectants, buffering agents, and mineral salts.

According to embodiments, the substance may be applied to the perishable product using a carrier, which may be a gas or a liquid, depending on whether the substance is applied as a dry treatment or a wet treatment. According to embodiments, the substance may comprise a functional diluent or solvent, including but not limited to water, ionized water, chlorinated water, electrochlorinated water, ozonated water, ethanol, isopropyl alcohol, and the like. A functional diluent is one that also provides efficacy to control or reduce bacterial contamination, and/or makes the delivery of the substance to the product more efficient and effective and/or enhances the usefulness of the substance to achieve the intended and desired outcome. According to embodiments, the substance may comprise a sanitizer, including but not limited to chlorine dioxide, hydrogen peroxide, peracetic acid, ozone, and other gaseous forms of sanitizers and the like. According to embodiments, the substance treatment may be an oxidizing agent or a reducing agent. According to embodiments, the substance treatment may comprise an essential oil, including but not limited to lemon oil, orange oil, grapefruit oil, rosemary oil, sunflower oil, other fruit-derived oils, tea tree oil, cinnamon oil, rose oil, eucalyptus oil and the like. According to embodiments, the substance may comprise a surfactant including but not limited to potassium oleate, sodium dodecyl sulfate (SDS) and the like. According to embodiments, the substance may comprise a humectant including but not limited to sorbitol, glycerin, glycerol and the like. According to embodiments, the substance may include buffering agents and/or mineral salts including but not limited to ascorbic acid, citric acid, sodium bicarbonate, calcium phosphate and the like. According to embodiments, the substance may include aroma and flavor compounds including but not limited to pure fruit or vegetable essences, extracts, or essential oils, or ethyl acetate, esters, linear terpenes, cyclic terpenes, alcohols, aldehydes, esters, ketones, lactones, thiols and the like. According to embodiments, the substance may be an anti-browning substance, an ethylene scavenger including but not limited to potassium permanganate, a ripening agent (ethylene or ethylene generating compound), a nutritional substance, a probiotic, coloring, nano particles, phages, enzymes, or a sugar substance.

According to embodiments, the substance may remove or deactivate harmful compounds on the perishable product. According to embodiments, the substance may be electrical energy, electrical pulses, ultrasound, UV light, or other electromagnetic treatment. Non-thermal directed energy may activate substances already applied to the surface of the product and/or may be a substance treatment in and of themselves by impacting the electrons and subsequently damaging or destroying microorganisms or converting pesticides or other substances or undesirable chemical compounds into harmless compounds. According to embodiments, the substance treatment may be directly ionizing surface moisture, water, or a prescribed and specific liquid compound on the surface of the product. According to embodiments, the electrical current may be turned on and off as needed to provide an efficient and effective sanitization treatment.

The substance may include, for example, a sanitizing substance, a flavoring substance, a preservative substance, a food additive substance, a coating substance, a sealing substance, an essence and/or essential oil substance, a mineral substance, a vitamin substance, a biological substance, a hydrocolloid, a cyclodextrin, and other substances. The sanitizer substance may be in the form of a gas, a liquid, atomized, or a vaporized liquid, and may include, for example, ozone, nitrous oxide, inert gases, chlorine in all its forms, hydrogen peroxide in all of its forms, peracetic acid, nitrite and nitrate compounds, iodine, benzoates, propionates, nisin, sulfates, and sorbates or any other suitable gas or gaseous sanitizer. The flavoring substance may include any flavoring that is suitable for application to and/or infusion in the products.

Additionally, the substance may include one or more of coloring substances, food grade acid substances, mineral salt and/or mineral salt solutions, nutritional additives, sweeteners, flavor enhancers, and the like. The extracts, essence and/or essential oil substance may be in the form of a gas, a liquid, or a vaporized liquid, and may include, for example, essential oils from fruits (e.g., strawberries, blueberries, raspberries, blackberries, pomegranates, grapes, lemons, grapefruits, oranges, other citrus, cherries, and the like), vegetables, flowers, and other perishable food products, including, for example but not limited to, mint, clove, green tea, rose hips, hibiscus, ginseng, cacao. According to embodiments, the substance may be rose oil, rose essence, or a fruit essence. An essence substance may possess in high degree the predominant qualities of a natural product (as a plant or drug) from which it is extracted (as, for example, by steam distillation or infusion). An essential oil substance may include a concentrated hydrophobic liquid containing volatile aroma compounds of the plant or product from which it was extracted. An essence and/or essential oil substance may be collected from distillate from processing fruit products and may have antimicrobial and/or anti-fungal properties. An exemplary essential oil may include thyme oil (thymol; 2-isopropyl-5-methylphenol, IPMP). The mineral substance may be in the form of a gas, a powder, a liquid, a fluidized compound, a vaporized liquid. The vitamin substance may be in the form of a gas, a powder, a liquid, a fluidized compound, or a vaporized liquid, and may include, for example but not limited to, thiamine hydrochloride, riboflavin (Vitamin B2), niacin, niacinamide, folate or folic acid, beta carotene, potassium iodide, iron or ferrous sulfate, alpha tocopherols, ascorbic acid, Vitamin D, amino acids (L-tryptophan, L-lysine, L-leucine, L-methionine) or any other suitable gas, powder, liquid, or vaporized liquid vitamin substance. The biological substance may be in the form of a gas, powder, micro or nano particle, a fluidized compound, a liquid, or a vaporized liquid, and may include, for example, probiotics such as Lactobacillus and Bifidobacterium or any other suitable gas, liquid, or vaporized liquid biological substance. Probiotics may include live microorganisms that may confer a health benefit on the host when consumed such as, for example, naturally occurring beneficial or “friendly organisms” which are biologically active against pathogenic and spoilage organisms. In accordance with an embodiment, the biological substance can be added to the sealed enclosure, for example, after a sanitization cycle/sequence has occurred or as part of a standalone treatment and may provide benefits by, for example, crowding out harmful organisms on the surface of the perishables and/or providing antimicrobial and anti-fungal properties. The hydrocolloid substance may include, for example but not limited to, alginate, pectin, carrageenan, gelatin, gellan, and agar. The substance may include, for example but not limited to, one or more of calcium sulfate, ammonium phosphate, Ascorbic acid, citric acid, sodium benzoate, calcium propionate, sodium erythorbate, sodium nitrite, calcium sorbate, potassium sorbate, BHA, BHT, EDTA, tocopherols (Vitamin E), Citrus Red No. 2, annatto extract, beta-carotene, grape skin extract, cochineal extract or carmine, paprika oleoresin, caramel color, fruit and vegetable juices, saffron, supplements, and phages.

According to embodiments, the substance may be a pigment. According to embodiments, the substance may be a photosensitizer. According to embodiments, the substance may be a light sensitive compound.

According to embodiments, the dwell time, that is, the amount of time the substance remains active on the perishable product, may be manipulated to obtain the desired outcome. According to embodiments, the appropriate dwell time may be seconds to hours to days. According to embodiments, the dwell time is adjusted to enable the substance containing sanitizer to properly kill or render inactive the microorganisms present. According to embodiments, a defined dwell time of a substance may be selected based upon its purpose and characteristics or properties where the substance could have a short or long target dwell time. For example, the use of a strong sanitizer solution with a kill on contact or in only seconds requires a short dwell time, whereas a sanitizer such as a light solution of acid would necessitate a longer required contact time to have an effect on microorganisms. Other substances such as mineral salts, essential oils, or essences would remain active on the product to final consumption or use. According to embodiments, it is desirable to use a very strong sanitizer to obtain the best sanitizing effect. According to embodiments, the sanitizer may be peroxyacetic acid, acetic acid, ozone, hydrogen peroxide, ionized hydrogen peroxide, or essential oils. However, using a very strong sanitizer would likely have a damaging effect on the perishable product. According to embodiments, a strong sanitizer is used to treat the perishable product, followed by an additional treatment after the appropriate dwell time of the sanitizer to deactivate, dilute, diminish, or remove the sanitizer to prevent damage to the product. According to embodiments, the dwell time for peroxyacetic acid and acetic acid may be one minute to several hours. According to embodiments, the dwell time for ozone and hydrogen peroxide may be seconds to minutes. According to embodiments, the dwell time for essential oils may be minutes to days.

According to embodiments, the substance treatment may remove, deactivate, or otherwise neutralize a substance that is on the perishable product. For example, some perishable products may be contaminated with chemical compounds such as herbicides and/or pesticides and therefore require washing and/or treatment to convert those chemicals into harmless compounds that can simply rinse away and be deactivated. For example, pesticides such as carbamate and organophosphate undergo a chemical reaction on contact with high pH ionized alkaline water called alkaline hydrolysis, which breaks down the active ingredient in those pesticides into harmless compounds, which are easily washed away. According to embodiments, the substance non-thermal treatment may be directed electrical energy, electrical pulses, ultra sound, UV light, electromagnetic treatments, whereby they activate substances already applied to the surface of the product, and/or are used as standalone substance treatments by impacting the electrons and subsequently damage or destroy microorganisms or convert pesticides or other substances or undesirable chemical compounds into harmless compounds.

According to embodiments, one or more devices deliver directed (assisted) or targeted treatment of one or more substances to a product between the time it is harvested and the time it is packaged. According to embodiments, a method is provided comprising determining, selecting and programming a desired product treatment outcome in terms of sanitization, protection, preservation or enhancement of the perishable product.

According to embodiments, the directed substance treatment may be in addition to a washing or sanitization step. According to embodiments, the washing or sanitization may be wet or dry (e.g., wet or dry washing). Wet washing may include a material contacting or coating the perishable product. According to embodiments, wet washing does not include immersion of the perishable product within a liquid (e.g., water). According to embodiments, applying the functional treatment with wet washing does not saturate the perishable product with excess moisture. That is, for example, wet washing the perishable product does not leave the perishable product saturated after treatment.

According to embodiments, applying the functional treatment with wet washing applies minimal additional moisture to the perishable product. For example, the substance treatments use a small or minimal amount of liquid as a substance and/or carrier. A minimal amount of liquid may be the lowest amount of product surface wetting needed to properly apply the substance to the perishable product. A minimal amount of liquid may be the lowest amount of product surface wetting needed to properly apply the substance without saturating the perishable product. A minimal amount of liquid may be the lowest amount of product surface wetting needed to properly apply the substance to the perishable product while not changing the surface moisture level. In some embodiments, applying the functional treatment will be dry washing such as, for example, using air or industrial gas as a carrier. In some embodiments, a mixture of gas and liquid such as, for example, N2 and alcohol, as a carrier. In some embodiments, a small micron size liquid particle spray using very small volume of liquid. In those cases, the moisture level on the product surface will not change or change very little. Accordingly, the amount of liquid required and the residual surface moisture may be well managed, delivering the most effective and cost efficient substance treatment for enhancing the perishable product and achieving the prescribed outcome.

According to embodiments, the one or more devices may be electrostatically charging devices, nebulizers, directed sprayer of ionized (acidic or alkaline) water, ozonated water, or electrolyzed water, directed sprayer of ionized air, or any combination thereof. According to embodiments, the devices may continuously manage the process by feedback loop to ensure sufficient treatment without the negative effects of overspray or overuse of materials (the negative effects including damage to the product, increased cost, and the environmental impact of increase in waste, among others). According to embodiments, the one or more devices are completely automated.

According to embodiments, the functional treatment may be applied in a continuous, surged, phased, or intermittent manner. In an example, the functional treatment may be applied at low levels (e.g., low energy levels) continuously. In an example, the functional treatment may be applied at high levels (e.g., high energy levels) intermittent. In some embodiments, it may not be desired to apply the treatment for a long period of time at high energy and in that case, may be applied either intermittently or at a lower level for a longer, continuous time period. In some embodiments, the application may be a shock wave format. For example, a first wave of treatment may be applied at a first energy level for a first duration. A second wave of treatment may be applied at a second energy level for a second duration. The first energy level may be higher or lower than the second energy level and/or the first duration may be longer or shorter than the second duration.

According to embodiments, the substance treatment may be applied in an open-air environment, meaning that the treatment does not need to occur in an airtight or nearly airtight sealed enclosure. According to embodiments, the substance treatment may be in a contained or semi-enclosed space such as a cabinet or a tunnel. According to embodiments, the perishable product may be on a conveyor line and pass through a tunnel where substance treatment occurs. According to embodiments, the substance treatment may occur within a centrifugal or tunnel dryer. According to embodiments, the substance treatment may occur within a forced air cooling unit. According to embodiments, the substance treatment may occur outdoors. According to embodiments, the substance treatment may occur in a fog tent. According to embodiments, the substance treatment may be a portable system. According to embodiments, the substance treatment may occur in a cold room or refrigerator. According to embodiments, the substance treatment may occur in a greenhouse. According to embodiments, the substance treatment may occur in an open air environment prior to packaging and/or final packaging of the product.

According to embodiments, the treatment device may apply an atomized substance to the perishable product. The atomization may be controlled which allows for the desired application of the anticipated wide range of substances, with different viscosity and/or fluid flow rates by managing and controlling the atomization energy. According to embodiments, atomization may be by centrifugation, in which the fluid is introduced to the center of a spinning disk and the fluid breaks up into fine droplets as it flows off the disk's edge. According to embodiments, the atomization may be ultrasonic atomization, in which fluid passes over a vibrating device that causes a breaking up of the fluid into droplets. According to embodiments, the atomization may be electrostatic, in which fluid is exposed to an electric field that tears the droplets from the atomizer and propels them towards the work surface. According to embodiments, the atomization may be pressure atomization, in which fluid is forced through an orifice at high speed, and friction disrupts the fluid stream and breaks it up into droplets. According to embodiments, the atomization may be air atomization which employs a high pressure air stream that surrounds fluid under low pressure and friction disrupts the fluid stream and breaks it into droplets. According to embodiments, the atomized substance can be delivered continuously, pulsed, sequenced, or intermittently.

According to embodiments, the treatment device may be a directed sprayer. According to embodiments, the spray system can include numerous types of manual and automatic spray guns and devices. According to embodiments, the spray may be an air spray. According to embodiments, the spray may be air-assisted, which combines hydraulic atomization of airless with air for fine atomization. According to embodiments, the spray may be airless, in which directs fluid under high pressure through a controlled orifice to accomplish airless atomization. According to embodiments, the spray may be electrostatic, in which material is electrostatically charged and is attracted to the grounded (neutral) or positively charged object/product to form an even coating. According to embodiments, the spray may be a compact paint gun, lightweight electrostatic gun, high-pressure air-assisted electrostatic spray gun, low pressure air-assisted spray gun, manual electrostatic paint gun, automatic electrostatic spray gun, direct charging, tribo-charging, or post-atomization charging. According to embodiments, the distance of the directed sprayer from the perishable product and the volume of substance use may be adjusted to optimize coverage of the perishable product. According to embodiments, the directed sprayer may be timed to turn on and off to coat the perishable product with minimal waste.

According to embodiments, the treatment device may be a nebulizer. According to embodiments, the substance may be applied by a nebulizer to vaporize the substance and enable surface contact and coverage, or adsorption or infusion of the substance. According to embodiments, the nebulized substance may become part of the air or gaseous environment, evaporated or vaporized to achieve a specified amount or concentration added to the carrier gas or air. According to embodiments, the treatment device may be a fogger. According to embodiments, the treatment environment may be manipulated with any of the treatment devices discussed herein in order to obtain the optimal application and coverage of the substance on the perishable product.

According to embodiments, the system and methods according to the invention treat perishable products with substances in unique ways and locations not previously conceived. Current production methods do not take advantage of their natural process to conceive of ways to sanitize or enhance the quality of the product. According to embodiments, substance treatment may be added to a forced air cooling chamber using ozone and essential oils during prolonged cooling steps. According to embodiments, substance treatment may be added to a cooling tunnel, cooling room, cooling chamber, tented, tarped, or partially contained, curtained, or contained environment with some capacity for products to enter and exit via an opening or unsealed entrance door or curtained opening and/or exit. A cooling tunnel passes pressurized or directed air flow directly across or through a perishable product in a specialized room or tunnel. A cooling tunnel differs from a cold holding room or refrigerated room, in which cold air is not being directed through or around the product. Rather, in a cold holding room or refrigerator the perishable product is passively allowed to acclimate to the inside air temperature. According to embodiments, a gaseous sanitizing step is applied in a cooling tunnel. According to embodiments, the sanitizer is carried using directed or pressurized air. According to embodiments, the gaseous sanitizing step includes ozone. According to embodiments, the gaseous sanitizer is recycled back into the cooling tunnel. According to embodiments, the substance may be applied during cooling of the perishable product in a cooling tunnel, a cooling room or chamber, or a ventilated space where the substance can be recirculated or directed across the surface of the product. According to embodiments, the method includes assessing whether it is desirable for the perishable product to be cooled. According to embodiments, the treatment may occur in a room, chamber, tented, tunnel, tarped, or partially contained, curtained, or contained environment with some capacity for products to enter and exit via an opening or unsealed entrance door or curtained opening and/or exit in which the directed air is not cooled. According to embodiments, the directed air is of ambient temperature. According to embodiments, the directed gas carrier may be forced across the surface of the perishable product. According to embodiments, using the forced air or pressure cooling or pressurized ripening rooms are also optional locations to apply the substance treatments efficiently either while cooling or ripening is in progress, or before or after the cooling or ripening process. According to embodiments, directed air from a pressurized gas gun or cannon may be used as the carrier for substance treatments that can coat or penetrate the surface of the perishable product. According to embodiments, the treatment includes a sanitizer, surfactant, and buffering agent. According to embodiments, the consumption of ozone and/or the presence of microorganisms is monitored.

According to embodiments, the perishable product may be treated inside of a film forming mechanism or machine or just prior or simultaneous to when the package is formed around the product. According to embodiments, the perishable product may be treated inside of a film forming tube which is a bag forming and filling machine prior to or simultaneous to when the package is formed around the product. According to embodiments, the perishable product is treated before final packaging of the perishable product. According to embodiments, final packaging may include all government approved food contact packaging materials and consumer packaging: before filling, during filling of the product into the package, in conjunction with, or simultaneous to the final packaging of the product. Types of consumer product packaging include but are not limited to: a tray, punnet, clamshell, pouch, cup, bowl, bag, flow wrapped package, box, these materials could include any standard packaging material including plastic, fiber based (pulp, cardboard, paper chipboard), or glass.

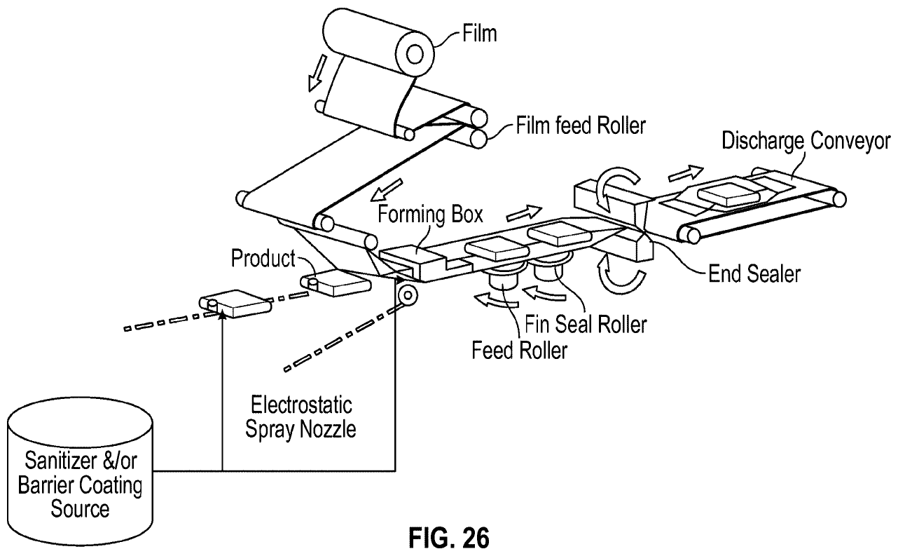

According to embodiments, the perishable product may be treated inside of a film forming mechanism or machine or just prior or simultaneous to when the package is formed around the product, as shown in FIG. 26. The controlled final treatment of FIG. 26 may be wet or dry substance treatments, directed at product on feed conveyor (surface treatment), directed at product inside film forming box (surface and/or atmosphere treatment), or combinations thereof.

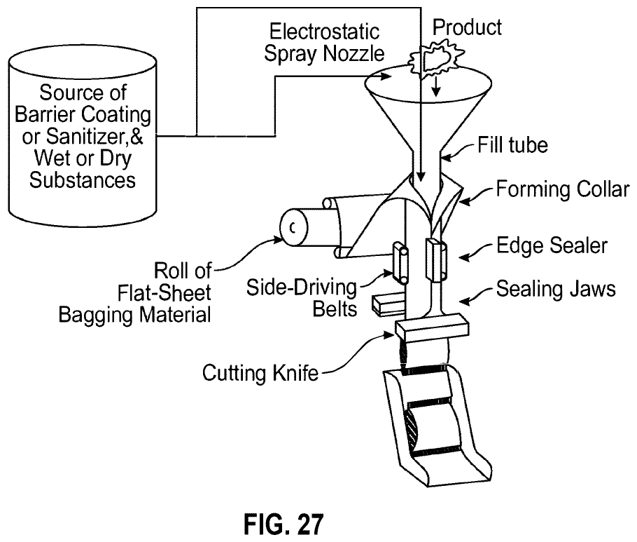

According to embodiments, the perishable product may be treated inside of a film forming tube which is a bag forming and filling machine prior to or simultaneous to when the package is formed around the product, as shown in FIG. 27. The controlled final treatment of FIG. 27 may be wet or dry substance treatments, directed at product falling into the feed tube (surface treatment), directed at product inside film forming tube (surface and/or atmosphere treatment), or combinations thereof. According to embodiments, the perishable product is treated before final packaging of the perishable product. According to embodiments, final packaging may include all government approved food contact packaging materials and consumer packaging: before filling, during filling of the product into the package, in conjunction with, or simultaneous to the final packaging of the product. Types of consumer product packaging include but are not limited to: a tray, punnet, clamshell, pouch, cup, bowl, bag, flow wrapped package, box, these materials could include any standard packaging material including plastic, fiber based (pulp, cardboard, paper chipboard), or glass.

According to embodiments, the substance treatment may be directed to the perishable product using an electrostatic spray to achieve enhanced directed spot and/or surface coverage. According to embodiments, the substance may be electrostatically charged before application to the perishable product. Prior to substance treatment, the perishable product may also be electrostatically charged, or grounded, or a state that will facilitate an electrostatic charge. The perishable product and the substance may be oppositely charged to increase the attraction between the perishable product and the substance. The electrostatically charge substance may be applied to the perishable product using directional assisted air or industrial gas flow and/or a pressure gradient allowing charged treatments to directly contact and benefit the perishable product. The electrostatic charge may be applied by a mechanism, including a nozzle or spray bar. The electrostatically charged substance treatment thereby increases the efficacy and efficiency of applying the substance to the perishable product.

According to embodiments, the electrostatically charged substances can be applied to the entire surface or to parts of products as coatings. The application of the electrostatically charged substance is enhanced by electrostatically charging the perishable product with the opposite charge as the substance. The oppositely charged product and substance are attracted to each other, which facilitates the coating the product with the substance, and that the substance remains in contact with the product. Charging the product also allows for accurate and precise application of the substance. The substance treatments may be applied in large or very small amounts, designed to interact or combine on the product surface and/or to provide a specific benefit/value to the product(s). For example, a product may have its surface charged or pretreated to efficiently accept an oppositely charged substance such as a very specific and defined quantity/treatment level of a highly active sanitizer.

According to embodiments, electrostatic treatment and substance application of perishable products may involve simultaneous or sequenced applications. For example, products may be quickly and efficiently treated on a packing line or at a fill station as the products pass by. According to embodiments, the electrostatically charged substance may be applied from above, below and/or the sides of the product as the product moves through the packing line. According to embodiments, charged particles and substances treatments may utilize a directed gas, liquid, volatilized liquid, atomized liquid, air flow, or air pressure as a carrier to aid in their application, and may appear as a spray bar, gas nozzle, and/or electrostatic charging bar above, below, and/or on the sides of the product as it passes by the treatment area. The substance treatment(s) may be applied horizontally or vertically, prior to packaging or in combination with the packaging process. According to embodiments, the product packaging may also include modified atmosphere treatments that work in combination or independently of the electrostatically charged product(s), and/or multiple electrostatically charged particles, compounds, and/or substance treatments.

According to embodiments, the product is positively charged. According to embodiments, the product is negatively charged. According to embodiments the product may not be electrostatically charged. According to embodiments, the product and the substance are oppositely charged. According to embodiments, the substance is positively or negatively charged, while the product is not electrostatically charged. According to embodiments, the first substance is positively or negatively charged, and an oppositely charged second substance is layered over the first substance. According to embodiments, the product is charged, and the substances are oppositely charged. According to embodiments, several substances are used to treat the product. According to embodiments, several substances are premixed and then applied to the product. According to embodiments, more than one substance is used to treat the product, each at different points of the processing line. According to embodiments, the more than one substance may have the same or different charges.

According to embodiments, the substance treatment may be part of a multistep substance treatment. According to embodiments, the multistep substance treatment may achieve a synergistic effect such that the overall result is improved compared to the individual steps alone. According to embodiments, the multistep substance treatment may comprise pretreatment, treatment, and post-treatment steps. According to embodiments, the pretreatment, treatment, and post-treatment may use the same or different combinations of ingredients. According to embodiments, the multistep substance treatment enables effective reduction/killing/rendering inactive microorganisms while also providing other functional benefits such as humectants, mineral salts, and aroma to enhance quality, shelf life and physical characteristics of the product. According to embodiments, a pretreatment may prep the surface of the product, target the organism and/or biofilm in one treatment making subsequent treatments more effective. According to embodiments, the one or more sanitizer pretreatments may be followed by a substance to enhance the physical characteristics of the now cleaner product surface. According to embodiments, a subsequent or post-treatment may coat the surface to prevent further growth of microorganisms on the now sanitizer treated surface. By using one or more sanitizer pretreatments with post-treatment coating, less rejected products may result due to the reduction in the number of defects. According to embodiments, sequencing the treatments provide synergy compared to combining or mixing the substances into one treatment. According to embodiments, the pretreatment substance may be directed/targeted to and attack a microorganism or break down biofilm on the surface of the perishable product to reduce microorganism levels. According to an embodiment, the perishable product may first be treated with hydrogen peroxide followed by a chlorinated water wash. According to an embodiment, the perishable product may first be treated with a surfactant followed by a wash step including a sanitizer. According to an embodiment, the perishable product is treated with a sanitizer followed by one or more steps to apply a coating to seal the product surface. According to embodiments, the coating may be a durable coating. According to embodiments, the coating may be non-permeable, permeable or be semipermeable coatings using designed patterns of application, etching, chemical or mechanical treatment, material selection, thickness and composition of waxes, foams, minerals, gels, gas infused substances, and other means to create intentional gaps, or desired moisture or gas transmission characteristics in the coating. According to embodiments, the durable coating may include cellulose, chitosan, alginate, potato starch, carboxymethylcellulose, aloe vera gel, calcium caseinate, whey protein, gelatin, soy protein, butyl acetate, plant based waxes, or any common commercially available food grade waxes and coatings, and the like.

According to embodiments, combinations of sanitizer substances may be used within a treatment, within a multistep treatment, and/or within a sequence of treatments to kill or render inactive microorganisms. According to embodiments, sanitizers may include ozone, ionized water (acidic or alkaline), chlorine dioxide, hydrogen peroxide, ionized hydrogen peroxide, peroxygen bleach, peracetic acid, essential oils and terpenes, ethanol, mineral salts, phages, and the like.

According to embodiments, a substance may be applied to the perishable product in an inactive or less active form, and then subsequently activated by applying a second non-thermal substance, a light wave, a sound wave, pH change, luminescence, enzyme, water, electricity/electrical charge, an energy pulse, a short term change in or cycling of the environmental conditions or other artificial means. According to embodiments, the activation may create a new substance or different form of the substance that has sanitization or other properties to enhance, preserve or protect the product. For example, substances such as peroxygen bleach may have properties that make them incompatible to be pre-mixed with other components or they are unstable in the completed form, therefore, forming them “in-situ” is a viable method of use. According to an embodiment, two substances may be independently applied to the surface that react to create a sanitizer that would have efficacy. According to an embodiment, a substance may be applied to the surface and would become a sanitizer under a change in pH or presence of luminescence, etc.

According to embodiments, sensor technologies including visual, light, sound, temperature, magnetic, and chemical sensing devices can be connected to a transducer that will send signals to the controller when changes occur to assist with and/or facilitate system management. The use of a sensor such as a chemical sensor, may be a self-contained device or it can be an interconnected device that can be deployed at a location within the overall process, from harvest to final packaging, in order to provide information about the product, substance, and/or treatment process, such as the chemical composition of the treatment environment. As an example when there is a change in the chemical composition of the monitored environment, components inside the device interact selectively with the molecules present in the monitored environment. A transducer connected to this device sends a signal when a change occurs, and systems management can be adjusted in accordance with the programed levels or parameters to achieve the desired substance treatment level which in turn affects the product quality, safety, or shelf life outcome.

The use of sensors, such as sonar-pulse distance-sensing ultrasonic waves are sent from the sensor and detect a product, light pulses that are reflected by the objects and then detected again by a sensor can very accurately detect products, certain substances and quality aspects relevant to the substance and product treatments, infrared and thermal sensors can be used to detect conditions, such as the presence of a product or conditions on the products surface that are not visible to the human eye; image sensors can detect and convey information (about a product or capture a specific system aspect) of what constitutes an image. It is done by converting the variable attenuation of light waves into signals. These are used in the cameras which the system uses to create a digital image of the pictures taken by the interconnected camera device(s). That can be used for various purposes such as thermography, creation of multispectral images, sensor arrays for x-rays and other highly sensitive arrays for detecting aspects of the product, levels of contamination and/or the presence of microorganisms as well as providing data for managing product and substance treatments.

According to embodiments, sensor technology may be implemented to measure microorganism levels, presence of or remaining levels of a substance(s) used in the treatments, or coating performance levels and would make AI corrections in the application of the substance treatment to obtain preferred results. According to embodiments, a controller may receive data comprising at least one of environmental conditions, airborne fungal spore count, decay levels, pest count, soil quality, water conditions, crop conditions, mineral deficiencies, and growing conditions of the perishable product. In some embodiments, the controller may apply predictive artificial intelligence and machine learning to the received data to determine the substance for application.

According to embodiments, the method of using a substance to treat a perishable product may include measuring the presence of and/or amounts of microbes present on the surface of the perishable product, either before or after application of the substance. According to embodiments, an additional application of the substance may occur when the presence and/or amount of microbes is above a specified amount. According to embodiments, luminescence or other technology could be used to measure the amount or % coverage of substance on a product surface, remaining active substance or treatment ingredient level. Based on results, the process may make self-corrections or adjustments to improve performance. According to embodiments, sensor technology may be used to detect defects on the surface. According to embodiments, vision technology may identify or illuminate a spot on the product for treatment. According to embodiments, bioluminescence or similar technique may be used to determine treatment level or adjustment needed. Substance treatment may then be spot treated on the defect, thus alleviating problems associated with the current methods of defect removal, which end up removing a large percentage of good products in addition to the actual defect.

Through extensive study, the inventor has determined that the selection and combination of functional compounds for substance treatment may be selected based on a number factors, including but not limited to the purpose of the treatment, whether a wet or dry treatment should be applied to the product between harvesting, production and final packing, whether a sanitizing pre-wash treatment is used or needed, whether a final sanitizing surface treatment is used or needed, whether the final surface condition is wet or dry, whether there is a peel treatment and/or coating, the desired odor flavor contribution desired if any, whether there will be a wash or rinse step after the substance treatment, and whether there is a drying step after the substance treatment.

According to embodiments, the perishable product may be packed in a novel package, which may be used for cooling, treatment and packing. According to embodiments, the package may be a punnet or clamshell package with attached or separated lids. According to embodiments, the punnet may have a top flange where film is sealed to enclose the product. According to embodiments, the punnet may or may not be vented. According to embodiments, the top film may be vented, micro-perforated or designed for proper transpiration of oxygen and carbon dioxide. According to embodiments, the punnet's physical design would support nesting before use and then stacking when filled with the perishable product. According to embodiments, at harvest, the punnets may be filled and stacked within a transportation container. According to embodiments, if vented, the punnets may be cooled in forced air cooling, such as in a cooling tunnel. Preferable for both vented and not vented is de-nesting the punnets on a conveyor and then passing through a cooling tunnel. During the cooling step, the product is treated with sanitizer. Following cooling, the punnets have the lidding film sealed on the top flange. Immediately prior to or at the moment of sealing, a substance treatment may be applied. According to embodiments, the punnets are designed to be more environmentally friendly in terms of less material use and compostable, and may virtually eliminate plastic. According to embodiments, the punnet receiving portion and second half enclosing material may be environmentally friendly including natural, non-plastic materials that are compostable; functional enclosing material made of cellulosic or other natural fibrous woven material; are laminated with substances that provide direct or indirect treatment of the perishable product. According to embodiments, the punnets mirror the common footprint of PET punnets, so customers can avoid additional investments in tooling, and allow customers to easily swap in and out of compostable punnets without having to experience down time. According to embodiments, the punnet in combination with other process changes disclosed herein provide a beneficial means to apply substance treatments not available with current packing/process paradigms. The substance treatment can include when a) treatments are applied to the perishable product prior to packaging, or b) treatments are indirectly applied to the perishable product via the packaging, or c) the packaging is designed to benefit or enhance the value of the perishable product without a direct or indirect application to the perishable, such as ethylene or carbon dioxide absorption functionality.

Treatment in concert with the cooling step can be applied using multiple and/or sequential combinations of substances and treatment applications devices. Because the punnet surface may be “dry” to afford proper film sealing, the use of directed air/gas carried substances treatments, low volume electrostatic spray or nebulized substances such as essential oils minimize moisture present in this step. Embodiments of the punnet in combination with the system and methods described herein facilitate at least: 1) better and more efficient cooling dynamics 2) more effective and efficient directed substance treatments of the product, 3) use sensors, programming, feedback loops and management control processes to improve the process, 4) use less energy for cooling, 5) generate less waste and a smaller environmental impact. All of these improvements individually and/or collectively are significant when compared with the current method of field packaged berries in clamshells and boxes, that are palletized then tarp forced air cooled.

According to embodiments, a method of treating a perishable product may comprise incorporating a functional ingredient onto the surface of the packaging material. The functional ingredient may be selected to be functional while remaining on the surface of the packaging material, or it may transfer from the packaging material to the surface of the perishable product.

According to embodiments, the perishable product may be minimally processed foods, consumer products, bulk or wholesale products, raw products, and/or ingredients for food and beverages. According to embodiments, the perishable product may be a protein, such as meat, foul, fish, or vegetable protein. According to embodiments, the perishable product may be a leafy vegetable, such as lettuce. According to embodiments, the perishable product may be berries. According to embodiments, the perishable product may be a stone fruit, such as peaches, plums, and cherries. According to embodiments, the perishable product may be a floral product, including fresh cut flowers or herbs. According to embodiments, the perishable product may be cannabis or hemp.

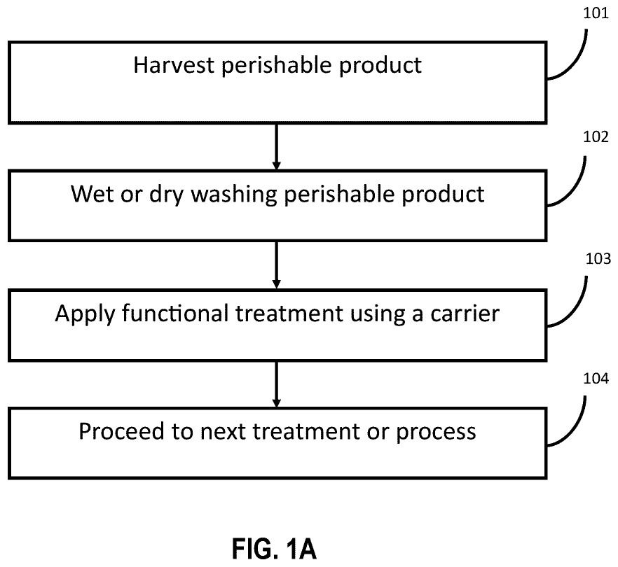

Referring to FIGS. 1A and 1B, shown are flowcharts that provide examples of the operation of various embodiments of the disclosure. It is understood that the flowchart of FIGS. 1A and 1B provide merely an example of the many different types of functional arrangements that may be employed as described herein. As an alternative, the flowcharts of FIGS. 1A and 1B may be viewed as depicting an example of elements of a method implemented according to one or more embodiments. Beginning with box 101, a perishable product is harvested. At box 102, the perishable product is wet or dry washed. At box 103, a functional treatment is applied using a carrier. Alternatively, as shown in FIG. 1B, the functional treatment is applied prior to wet or dry washing of the perishable product. At box 104, the treated perishable product moves to the next step in the process, which may be an additional functional treatment, inspection, or packaging.

According to embodiments, a method for treating a perishable product comprises: determining a desired product treatment outcome selected from sanitization, protection, preservation, or enhancement of the product; directly applying a first treatment of one or more functional substances to the surface of the perishable product after harvesting using a first carrier; and directly applying a second treatment of one or more functional substances to the surface of the perishable product prior to final packaging of the perishable product using a second carrier, wherein the different treatments and substances enhance the efficacy of each other, or activate or create a new substance or different form of the substance on the product surface and/or enhance the shelf life, quality, appearance, safety, organoleptic or other properties of the product that increase its perceived value.

According to embodiments, the direct application of at least one of the first treatment of substances or the second treatment of substances to the perishable product may occur in an open atmosphere environment is comprised of a room, chamber, tent, tunnel, tarped enclosure, or other partially contained environment with some capacity for the perishable product to enter and exit via an opening or unsealed entrance door or curtained opening or exit.

According to embodiments, the direct application of at least one of the first treatment of substances or the second treatment of substances to the perishable product may occur by directly treating the product in a bulk container, loose on a belt, on a pallet or groups of pallets, hanging on a line, or in an unsealed consumer package.

According to embodiments, the first treatment of substances may include a sanitizer to effectively eliminate or reduce surface spoilage and/or pathogenic organisms; and the second treatment of substances includes a durable coating intended to protect, preserve, or enhance the product.

According to embodiments, the first treatment of substances may include a surfactant and mineral salts or buffering agents; and the second treatment of substance may include a sanitizer intended to eliminate spoilage organisms on the surface of the product. According to embodiments, the first treatment of substances may use ionized water (alkaline or acidic) as the carrier; and the second treatment of substances may include an essential oil and/or essence to protect and enhance the product. According to embodiments, the first treatment of substance may use ozonated water as the carrier; and the second treatment of substances may include an essential oil and/or essence to protect and enhance the product. According to embodiments, the first treatment of substances may include a sanitizer to effectively reduce or eliminate surface spoilage organisms; and a second treatment of substances may include an essential oil and/or essence to protect and enhance the product; while a third treatment of substances may be applied to a portion of the product and may contain an ethylene absorbing or neutralizing material.

According to embodiments, the method may include using pulp based or paper materials, woven and non-woven materials, or foils; wherein the materials are sprayed with, coated, impregnated, laminated, or have printed on functional substances. This treated sheet material can be used to wrap the perishable product, inserted into the punnet with the perishable product, or wrap around a stack of punnets such as when palletized. In this manner, the functional substance is able to sanitize, reduce malodors, reduce ethylene or carbon dioxide levels, or add aroma.

According to embodiments, a method for treating a perishable product with a substance is provided, the method comprising: determining a desired product treatment outcome selected from sanitization, protection, preservation, or enhancement of the perishable product; applying an electrostatic charge to the substance; applying no electrostatic charge or an opposite electrostatic charge to the perishable product; and directly applying the electrostatically charged substance to a surface of the perishable product using a carrier to achieve directed spot or surface coverage.

According to embodiments, the first treatment of substance may use a strong sanitizer for a short time; and the second treatment of substance may deactivate, buffer, dilute, or generally reduce the chemical activity of the strong sanitizer before injury occurs to the product. According to embodiments, the method further comprises: activating at least one of the first substance or the second substance by applying an additional substance, a pH change, a UV or light wave, or a sound wave, an electrical charge; and wherein the activation creates a new substance or different form of the substance that sanitizes, enhances, preserves, or protects the perishable product.

According to embodiments, the substance treatment may be performed in a cooling tunnel, cooling room, cooling chamber, vestibule, partitioned space, or ventilated space wherein the substance may be directed across the surface of the product and can be recirculated back into the cooling room, cooling tunnel, vestibule, partitioned space, or ventilated space.

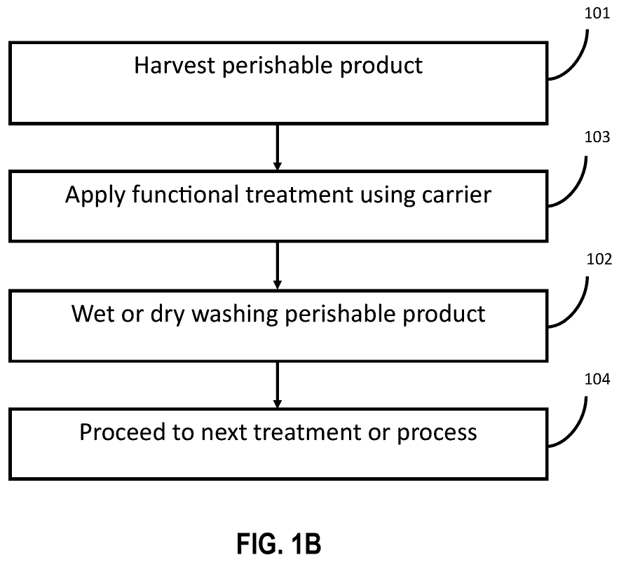

According to embodiments, a system for treating a perishable product with a substance treatment is provided comprising: one or more devices for directed substance application to a surface of the perishable product prior to or during filling of the final packaging of the perishable product using a carrier; a sensor for evaluating the surface of the perishable product; and a controller for controlling the directed substance application based on feedback from the sensor. As shown in FIG. 2, after the functional treatment is applied to the perishable product at box 103, the surface of the perishable product or the environment of the perishable product may be evaluated for contamination at box 105. Contamination may include, for example, dirt, debris, bacteria, mold, or spoilage. If contamination is present at step 106, the functional treatment is reapplied. If contamination is not present at step 106, the perishable product proceeds to the next step of the process.

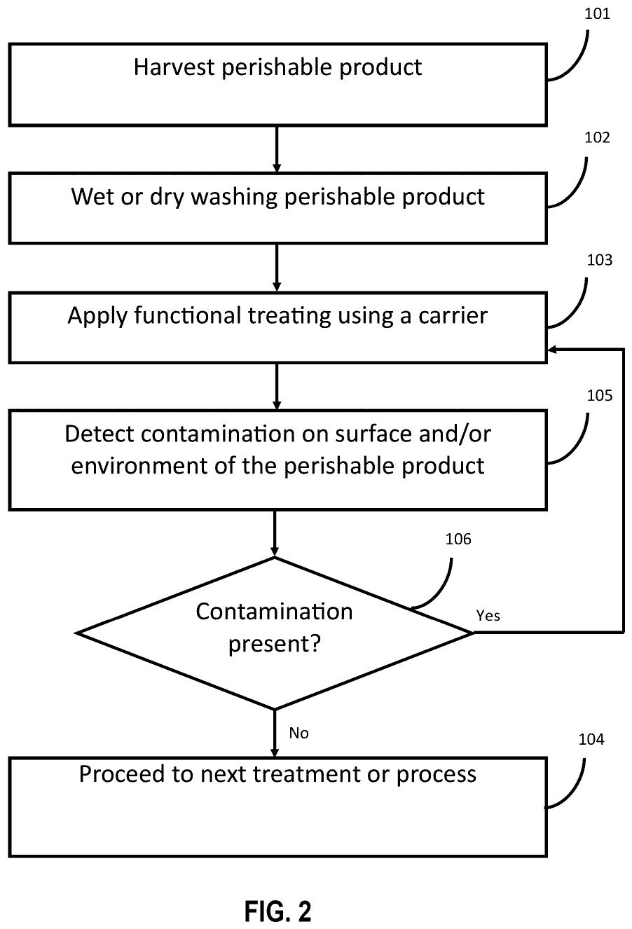

FIG. 3 shows an additional or alternative embodiment in which the surface of the perishable product is evaluated at box 107 to measure the amount of the applied functional treatment or the effect of the applied functional treatment. If the amount or effect of the functional treatment is below a predetermined threshold value at 108, the functional treatment is reapplied. If the amount or effect of the functional treatment is at or above the threshold value, the perishable product proceeds to the next step of the process.

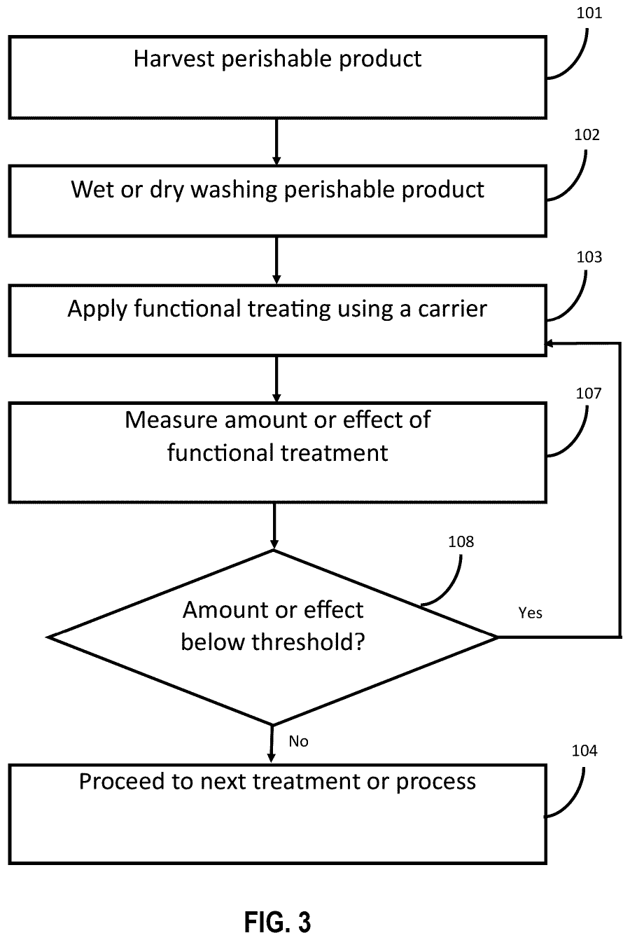

FIG. 4 shows a perishable product treatment system 200 according to various embodiments of the present disclosure. The perishable product treatment system 200 can include a product treatment zone 202 and a controller 208. Product treatment zone 202 can further include a treatment device 204 for applying the functional treatment to the perishable product and/or the perishable product packaging, and a sensor 206. The sensors may detect, for example, the presence or position of the perishable product, various aspects of the surface of the perishable product or the surface of the packaging or the environment surrounding the perishable product, the presence or absence of the functional substance, or the effect of the functional substance. Controller 208 may control various aspects of the treatment process including the amount and type of functional treatment.

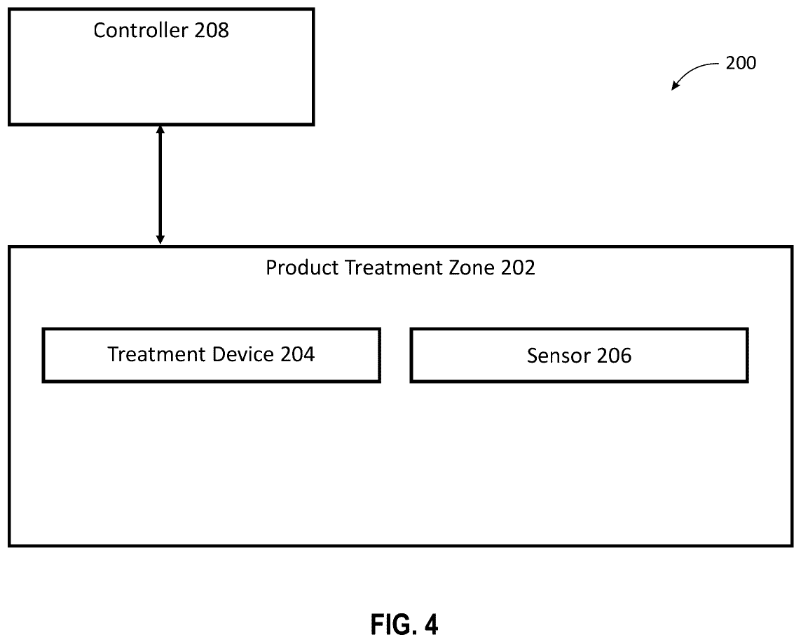

FIG. 5 shows a perishable product treatment system 300 according to various embodiments of the present disclosure. Perishable product treatment system 300 can include a product treatment zone 302 and controller 314. Product treatment zone 302 can include treatment device 304 for applying a functional treatment, sensor 308, and other treatment devices 306 for application of additional or alternative functional treatments, and other sensors 310. Product treatment zone 302 may include a conveyor 312 for automatically loading the perishable product into product treatment zone 302 and/or exiting the perishable product from product treatment zone 302 after application of the functional treatment.

According to embodiments, the perishable product may be treated with one or more substances immediately prior to, or simultaneous to entry inside of a film or package forming mechanism or film or package sealing mechanism. According to embodiments, the film or package forming or sealing mechanism may form a punnet, a package or bag around the perishable product. According to embodiments, the treatment may occur just prior to or simultaneous to when the package or bag is formed or sealed around the perishable product.

According to embodiments, the method for treating a perishable product further comprises: detecting a defect on the surface, cut, bruise, wound or other surface exception of the perishable product, and applying at least one of the first substance or the second substance on the defect on the surface of the perishable product.

According to embodiments, the substance may be selected from the group consisting of a sanitizer, an antifungal, an essential oil, a reducing agent, a surfactant, a humectant, a photosensitizer, a buffering agent, a mineral salt, alkali metal salts, an aroma, a flavoring agent, a sealing or coating substance, waxes, an anti-browning substance, an ethylene scavenger, hydrocolloid, cyclodextrins, lipids, metallic compounds, ethylene blocking compound, a ripening agent, a nutritional substance, a probiotic, coloring, nano particles, phages, enzymes, and sugar substance. According to embodiments, the substance may be selected from the group consisting of chlorine dioxide, hydrogen peroxide, ionized hydrogen peroxide, peracetic acid, ozone, ionized water, lemon oil, orange oil, grapefruit oil, rosemary oil, sunflower oil, other fruit-derived oils, tea tree oil, cinnamon oil, eucalyptus oil, potassium oleate, sodium dodecyl sulfate (SDS), ascorbic acid, citric acid, sodium bicarbonate, potassium carbonate, calcium phosphate, esters, linear terpenes, cyclic terpenes, alcohols, aldehydes, esters, ketones, lactones, thiols, lipase, rose oil, rose essence, and fruit essence.

According to embodiments, the treatment itself may not be a substance, but may be a temperature change, exposure to electrostatic charge or ionization, or exposure to UV light or a sound wave.

According to embodiments, the treatment itself may include microorganisms that do not contribute to decay or loss of quality. When present at a high population, they can create a natural barrier to prevent contamination or growth of harmful bacteria.

According to embodiments, the method for treating a perishable product further comprises: measuring and/or detecting microbes, chemical, or surface contamination present on the surface of the perishable product or within the immediate environment of the product; and applying an additional amount of the first substance or the second substance to the surface of the perishable product when the presence or amount of the microbes, chemical, or surface contamination present on the surface of the perishable product is above a specified amount.

According to embodiments, the method may further comprise: determining a defined dwell time of the first substance and a dwell time of the second substance based upon the purpose of the treatment and the characteristics of the first substance and the second substance; and deactivating, the first substance and/or the second substance when the defined dwell time of the first substance and/or the defined dwell time of the second substance have been reached.

According to embodiments, the first treatment of substance may break down biofilm on the surface of the perishable product and the second treatment of substance may effectively attack the spoilage organisms present. According to embodiments, the first treatment of substance may reduce or break down undesirable or harmful chemicals on the surface such as pesticides, herbicides, fungicides, fertilizers, growth regulators or wax coatings on the perishable product, and the second treatment of substance may provide a flavor or aroma to enhance the product.

According to embodiments, the substance may be applied by a nebulizer configured to vaporize the substance and enable surface contact and coverage, adsorption, or infusion of the substance.

According to embodiments, the at least one of the first treatment of substance or the second treatment of substance may slow, reduce, or prevent moisture loss of the perishable product. According to embodiments, at least one of the first treatment of substance or the second treatment of substance may slow, reduce, or prevent senescence of the perishable product. According to embodiments, at least one of the first treatment of substance or the second treatment of substance may be a preservative. According to embodiments, at least one of the first treatment of substance or the second treatment of substance may enhance color, brightness, flavor, aroma, or texture of the perishable product, or reduce, neutralize or mask undesirable characteristics such as malodor or flavor. In some embodiments, one of the first or second substances may contain solubilized alkali metal salts like potassium bicarbonate along with a cyclodextrin such as methylated alpha-cyclodextrin. According to embodiments, at least one of the first treatment of substance or the second treatment of substance may reduce, neutralize, or block ethylene or is an ethylene scavenger.

According to embodiments, the perishable products are lettuce products, tomatoes, berries, cherries, or highly perishable produce. According to embodiments, the perishable product is a protein including but not limited to meat, fish, fowl, and vegetable protein products. According to embodiments, the perishable product is cannabis and hemp or medicinal products. According to embodiments, the perishable product is a floral product including roses and cut flowers.

According to embodiments, a method for treating a perishable product comprises: determining a desired product treatment outcome selected from sanitization, protection, preservation, or enhancement of the perishable product; directly applying a substance to a surface of the perishable product after harvesting using a carrier; wet or dry washing the perishable product; and packaging the perishable product.

According to embodiments, a system for treating a perishable product with a substance treatment comprises: one or more devices for directed substance application to a surface of the perishable products prior to final packaging of the perishable product using a carrier; and wherein the one or more devices is an electrostatically charging device or a nebulizer.

According to embodiments, a method for treating a perishable product with a substance comprises: determining a desired product treatment outcome selected from sanitization, protection, preservation, or enhancement of the perishable product; evaluating the surface of the perishable product; and directly applying a substance to the surface of the perishable product after harvesting using a carrier based on the evaluated surface of the perishable product.

According to embodiments, a method for treating a perishable product comprises: determining a desired product treatment outcome selected from sanitization, protection, preservation, or enhancement of the product; wet or dry washing, sanitizing, cleansing or cleaning the perishable product; directly applying a substance to the surface of the perishable product after harvesting using a carrier; and applying a durable coating to the surface of the treated perishable product.

According to embodiments, the durable coating may inhibit moisture loss, discoloration, change in the visual, sensory, or organoleptic properties of the surface of the perishable product or controls moisture or gas transmission to the perishable product. According to embodiments, a substance may create a designed pathway through or disruption of the durable coating, to resemble a micro perforated effect, to enable some managed level of oxygen, CO2, and/or moisture transfer/exchange or transport to the product. According to embodiments, the durable coating or durable edible coating may include cellulose, chitosan, alginate, potato starch, carboxymethylcellulose, aloe vera gel, calcium caseinate, whey protein, gelatin, soy protein, and butyl acetate. In some embodiments, the designed pathway is created using selected substances, including micro- and nano-particles, and modern printing techniques (including 3D like circumferential printing) found in a number of applications in electronics, biotechnology, and material synthesis/patterning, and the functional treatment is transferred directly to the surface of the product.

According to embodiments, a method for treating a perishable product with a substance comprises: determining a desired product treatment outcome selected from sanitization, protection, preservation, or enhancement of the perishable product; applying an electrostatic charge to the perishable product; applying an opposite electrostatic charge to the substance; and directly applying the electrostatically charged substance to a surface of the perishable product using a carrier.

According to embodiments, a method of treating a perishable product with an electrostatically charged substance comprises: detecting an area on the surface of the perishable product prone to decay; applying an electrostatic charge to the perishable product; applying an opposite electrostatic charge to a substance; and directly applying the substance to the area on the surface of the perishable product prone to decay using a carrier.

According to embodiments, a system for treating a perishable product comprises: a treatment area having a perishable product inlet; a conveyor passing through the treatment area configured to transport the perishable product, the treatment area including: at least one treatment device configured for direct application of a substance to a perishable product based on a desired product treatment outcome, and a device for coating the perishable product based on the desired product treatment outcome; a controller for controlling treatment of the perishable product in the treatment area based on the desired product treatment outcome selected from sanitization, protection, preservation, or enhancement of the perishable product, wherein the controller controls at least one of the treatment device and coating device based on the desired product treatment outcome; and a packaging area configured to receive the perishable product from the treatment area, the packaging area including a container to package the perishable product.

According to embodiments, a method for sanitizing a perishable product with a substance comprises: placing a perishable product in a tunnel, chamber, or a ventilated space; determining and controlling the appropriate or prescribed dwell time and concentration for exposure to the sanitizer; and directly exposing or applying a substance to the surface of the perishable product using controlled and directed air or channeled recirculated air and/or industrial gas carrier in the tunnel, chamber, pass through channel, or chute, or ventilated or partially ventilated space.

According to embodiments, a method for treating a perishable product with a substance comprises: determining a desired product treatment outcome selected from sanitization, protection, preservation, or enhancement of the perishable product; evaluating or assessing a surface of the perishable product; determining the target surface area of the perishable product; selecting the prescribed substance to treat the surface of the perishable product based on the surface evaluation or assessment; selecting the target amount of substance to be applied to the surface of the perishable product based on the substance and the surface area of the perishable product; selecting the prescribed treatment time of the surface of the perishable product; determine the target carrier for applying the substance; determining the target distance from the surface for application of the substance; directly applying the optimal volume of the substance to the surface of the perishable product for the optimal treatment time at the optimal distance from the surface.

According to embodiments, the method further comprises detecting or measuring the amount or presence of the substance on the surface of the perishable product; reapplying the substance if the amount of the substance or coverage that is present on the surface of the perishable product is below a predetermined value; measuring the effect or presence of the substance that is present on the surface of the perishable product; and reapplying the substance if the effect or coverage of the substance that is present on the surface of the perishable product is below a predetermined value.

According to embodiments, a method for treating a perishable product comprises: directly ionizing the surface, substance, coating, or surface moisture on the perishable product, wherein the ionized treatment to the surface (moisture) sanitizes the surface of the perishable product.

According to embodiments, an apparatus for applying an electrostatically charged substance to a perishable product comprises: a directed electrostatic spray mechanism for applying an electrostatic charge to the perishable product, a treatment zone, a conveyor or mechanism for receiving the perishable product and passing through the treatment zone, and a second directed electrostatic spray mechanism for controlled and directed application of the electrostatically charged substance to the perishable product.

According to embodiments, the apparatus comprises: a directed air or industrial gas assisted spray, a conveyor or mechanism for receiving the perishable product and passing through the treatment zone, and a second directed air or industrial gas assisted spray mechanism for controlled and directed application of the substance to the perishable product.

According to embodiments, the apparatus comprising: a sensor for evaluating a surface and the surface area of the perishable product, a sensor that detects an area on the surface of the perishable product prone to decay, an automated program that determines the amount of the surface of the perishable product that is covered by the substance, and a meter for controlling the amount of the substance applied to the perishable product, and sensors to measure application efficiency and provide results feedback to the program.

According to embodiments, the apparatus includes sensors that measure application efficiency and provides a feedback loop to enable analyzing the results from the sensors, and meters and then using built-in improvement parameters, automatically determines the appropriate adjustments in the program for continually better usage and application of the substances and then overall performance and results.

According to embodiments, a method for treating a perishable product comprises: detecting or measuring the level of a component within a perishable product and comparing to a target level or amount that may be required to comply with quality, shelf-life, safety, or regulatory requirements; determining the amount or level of substance containing the component to add to adjust the level or amount of a product component, and then applying an additional amount or quantity of the component within the substance to infuse, apply to the surface, or coat the perishable product and then achieve the target amount or specified level of the component.

According to embodiments, the substance may be selected from the group consisting of at least one of: vitamins or nutritional compounds, minerals or flavonoids, flavor compounds or components, color compounds and components that express color, an essence and/or essential oil compounds, a sugar or sugar compounds, comprised of at least one of esters, linear terpenes, cyclic terpenes, alcohols, aldehydes, esters, ketones, lactones, thiols, THC or THC compounds, CBD or CBD compounds, cannabis derivates, or a combination thereof, linalool, limonene, lemon oil, orange oil, grapefruit oil, rosemary oil, thyme oil, sunflower oil, other fruit-derived oils, tea tree oil, cinnamon oil, or combinations thereof probiotic, phages, enzymes, or pharmaceutical compounds, or biological components or compounds, bioactive compounds such as germacrone a sesquiterpene and bioactive constituent of many essential oils, or such other natural compounds, components, or substances or chemicals present in perishable products to be adjusted to a target level.

According to embodiments, a method for treating a perishable product with a substance comprises: determining a desired product treatment outcome selected from sanitization, protection, preservation, or enhancement of the perishable product; determining the prescribed treatments including but not limited to sanitizing, neutralizing herbicides or pesticides; reducing, disrupting, deactivating, or eliminating undesirable contamination, reducing waste, moisture loss or dehydration and then using built-in improvement parameters, automatically determines the appropriate adjustments in the program for continually better usage and application of the substances and then overall performance and results.

According to embodiments, a punnet for cooling, treating, and packaging a perishable product comprises: a first half having a perishable product receiving portion; and a second half fitting over the product receiving portion, wherein the second half removably engages with the first half thereby enclosing the product receiving portion, the punnet having a top flange where film is sealed, snap sealed, affixed, or other type of sealing to enclose the punnet when the second half is engaged with the first half. According to embodiments, the first half and second half may be attached along a single edge forming a clamshell. According to embodiments, the punnet may contain vents. According to embodiments, the film may be vented or contain micro-perforations. According to embodiments, the film may be permeable to oxygen and carbon dioxide. According to embodiments, the film or lidding material may have controlled permeability to oxygen, carbon dioxide, and moisture. According to embodiments, the punnet may be designed to nest inside other punnets and may have a stacking tab or element that enables one punnet to support another punnet when stacked on top of each other. According to embodiments, the punnet may further comprise a scannable label; and a closure and coupling device configured to engage to a feed system. According to embodiments, the punnet may be made of natural, environmentally friendly, compostable or recyclable materials. According to embodiments, the film may be made of natural, environmentally friendly, compostable or recyclable materials.

According to embodiments, a method for treating a perishable product with a substance using a punnet comprises: placing the unsealed punnet containing the perishable product in a cooling tunnel; directing ambient temperature or a cooled gas carrying the substance through or across the punnet; and sealing the film to the top flange. During the various steps in this process, beneficial substance treatments may be applied. According to embodiments, the method may further comprise laminating one or more functional substances onto the surface of the inside of the punnet or on the enclosing material. According to embodiments, the functional substances may include those substances able to neutralize, absorb, or block ethylene; absorb or neutralize malodors; absorb or neutralize carbon dioxide; or sanitize or reduce fungus or mold spores that may be present.

According to embodiments, a method for treating a perishable product comprises: incorporating a functional ingredient onto a surface of a packaging material; and packing the perishable product into the packing material; wherein the functional ingredient transfers from the packaging material to the surface of the perishable product or wherein the functional ingredient does not transfer from the packaging material to the surface of the perishable product. According to embodiments, the functional ingredient may neutralize, absorb, or block ethylene; absorb or neutralize malodors; absorb or neutralize carbon dioxide; or sanitize. According to embodiments, the functional ingredient does not transfer to the surface of the perishable product. In this embodiment, there may be indirect or non-transfer of the functional ingredient. This may not directly transfer to the product, but rather, indirectly transfer to the product by improving the packaging itself and/or provide other beneficial effects such as, for example, on the environment within or surrounding the perishable product.

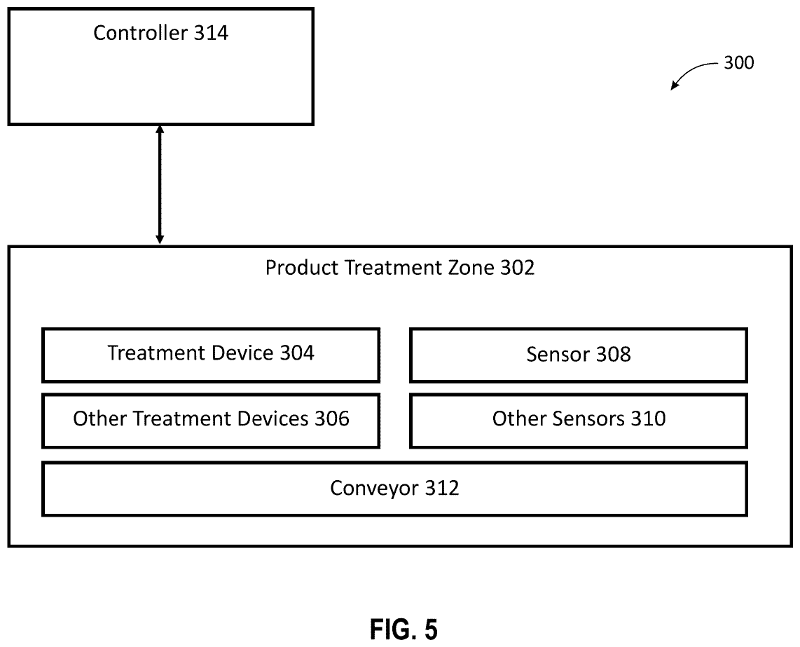

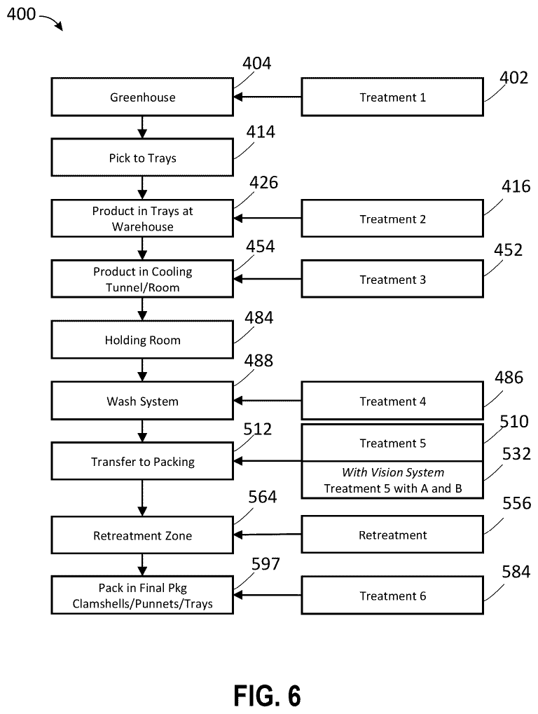

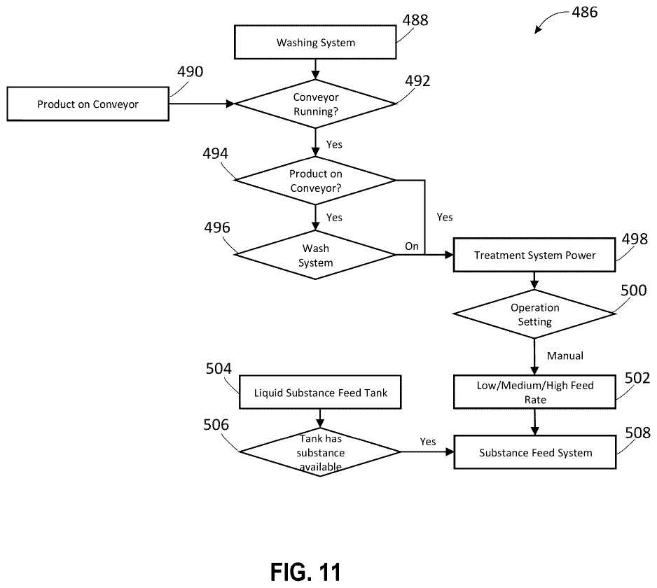

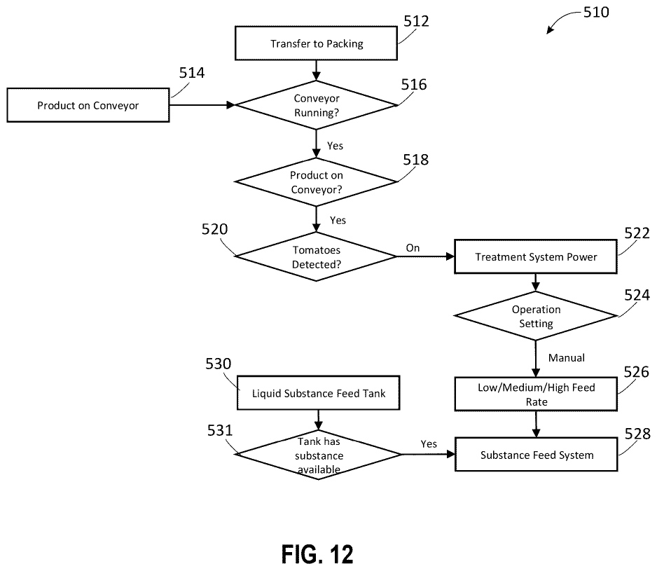

FIG. 6 is an overview of an example of the process flow and treatment locations according to various embodiments of the present disclosure, as illustrated in FIGS. 7 through 16. For illustration purposes, the product represented in FIGS. 6 through 16 is a tomato; however it is understood that the steps can be applied and adapted to any perishable product. Treatment process 400 may include, for example, at least six different points between the field and final packaging for functional treatment of a perishable product. The product may receive first treatment 402 prior to or just after harvest when in greenhouse 404. Next, the product is picked and placed into trays at step 414. The trays are moved to a warehouse at step 426, and may receive second treatment 416. The product is then moved to a cooling tunnel/room at step 454, and may receive third treatment 453. The product is then moved to holding room 484 and then to wash system 488, and may receive fourth treatment 486. The product is then transferred to packing at step 512, and may receive either fifth treatment 510 (FIG. 12) or fifth treatment with vision system 532 (FIG. 13). The product is then transferred to retreatment zone 564 and may receive retreatment step 556. The product is then packed in final package (for example, clamshells, punnets, trays, etc.), and may receive sixth treatment 584. It is understood that one or more of the treatments outlined in FIG. 6 may be used alone or in any combination with the other treatments described in the present disclosure.

Referring to FIG. 7, first treatment 402 is described. The product is first evaluated pre-harvest in the field or greenhouse 404 while the product is still on the plant. For example, the product may be evaluated to determine if it is at high risk for mold and fungus at step 406, and if yes, sanitizer and antifungal 408 may be applied using electrostatic charge fogging sprayer 410 while the product is on the plant pre-harvest at step 412.

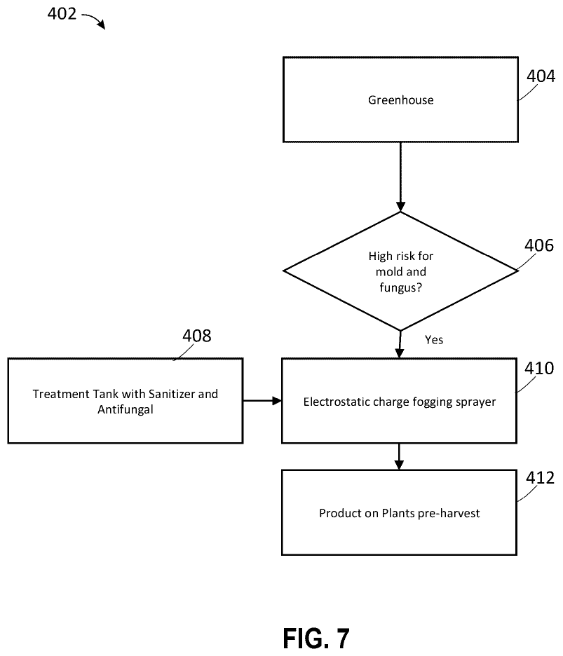

Referring to FIG. 8, second treatment 416 is described, in which the product is treated postharvest, either prior to or after cooling. The product is received in the cooling facility at step 418 and assessed for risk for mold and fungus growth at step 420. If the product is at high risk for mold and fungus growth, sanitizer and surfactant 422 is applied to the product using a high pressure sprayer 424 while product is in picking trays at step 426.

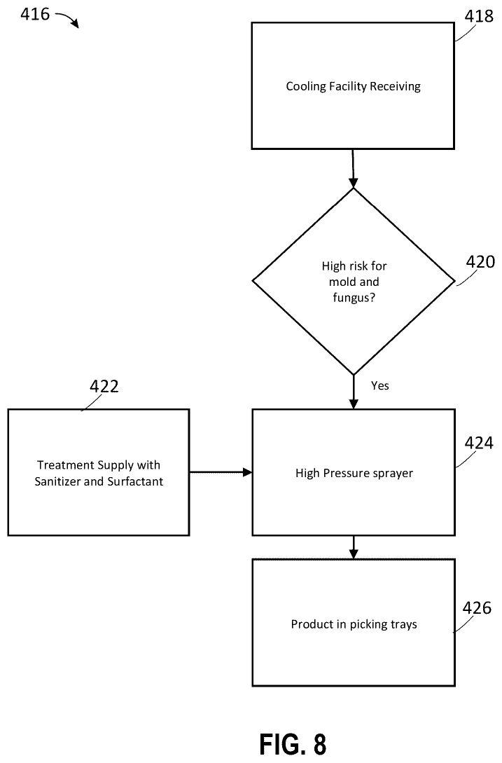

Referring to FIG. 9, an alternative second treatment is described, in which the product is treated postharvest, either prior to or after cooling in a contained chamber. At step 430, the product is received in chamber 428. The chamber doors are closed at step 432, and the carrier/air recirculation is turned on at step 434. Treatment system power 436 is on and operation settings 438 control the system, such as turning the substance feed on/off and controlling the feed rate at step 452. Gaseous substance feed system 448 and liquid substance feed system 450 supply the functional substance applied to the product, and are controlled by operation setting 438. Component measurement sensor 440, treatment coverage sensor 442, and micro-organism sensor 444 evaluate the product to determine whether the applied component, treatment coverage, and micro-organism levels, respectively, are within a target range. If the component, treatment coverage, and/or micro-organism level are not within a target range, gaseous substance feed system 448 and/or liquid substance feed system 450 initiate additional substance treatment to the product.

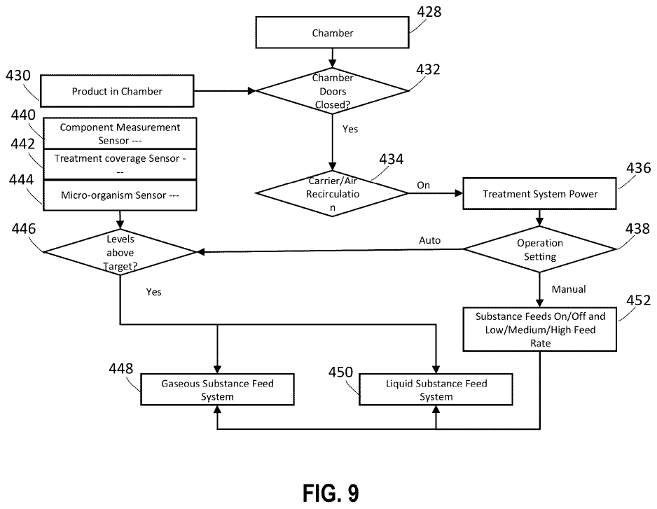

Referring to FIG. 10, a third treatment 453 is described, in which the product is treated in the cooling room. At step 454, the product is in the cooling room. Cooling system 456 is initiated and cooling room doors are closed at step 458. Temperature sensor 460 determines whether the cooling room temperature is above a target temperature at step 462. When the temperature is above target, cooling is initiated at step 464. Treatment system power 466 is on and operation settings 468 controls the system, such as turning the substance feed on/off and controlling the feed rate at step 482. Gaseous substance feed system 478 and liquid substance feed system 480 supply the functional substance applied to the product, and are controlled by operation setting 468. Treatment coverage sensor 470, component measurement sensor 472, and micro-organism sensor 474 evaluate the product to determine whether the treatment coverage, applied component, and micro-organism levels, respectively, are within a target range. If the component, treatment coverage, and/or micro-organism level are not within a target range, gaseous substance feed system 478 and/or liquid substance feed system 480 initiate additional substance treatment to the product.

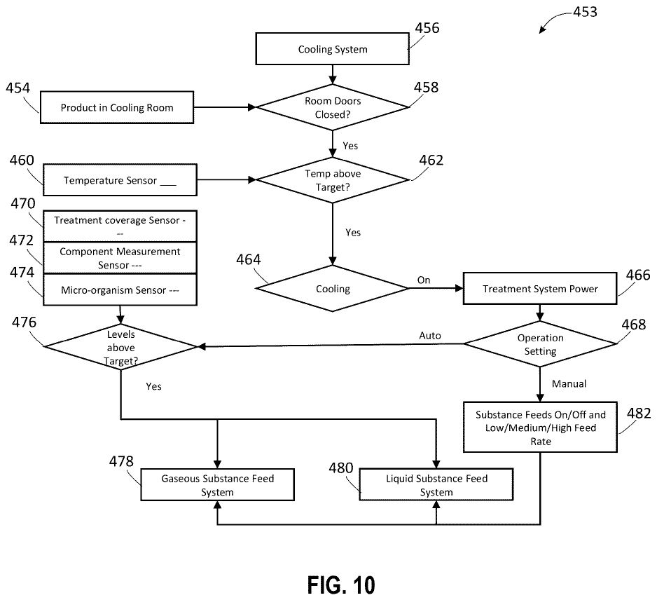

Referring to FIG. 11, a fourth treatment 486 is described, in which the product is treated in washing operations. At step 490, the product is loaded onto a conveyor. Washing system 488 is initiated, conveyor is checked to ensure it is running at step 492, and the product is confirmed on the running conveyor at step 494. Wash system 496 and treatment system power 466 are on, and operation setting 500 controls the system, such as turning the substance feed on/off and controlling the feed rate at step 502. Liquid substance feed tank 504 supplies the functional substance applied to the product, and is controlled by operation setting 500. Substance availability in liquid substance feed tank is confirmed at step 506, and substance feed system 508 applies the substance to the product.

Referring to FIG. 12, a fifth treatment 510 is described, in which the product is treated during transfer to packing. At step 514, the product is loaded onto a conveyor. Transfer to packing is initiated at step 512, the conveyor is checked to ensure it is running at step 516, and the product is confirmed on the running conveyor at step 518. The product is detected at step 520, and treatment system power 522 is on. Operation setting 524 controls the system, such as turning the substance feed on/off and controlling the feed rate at step 526. Liquid substance feed tank 530 supplies the functional substance applied to the product, and is controlled by operation setting 524. Substance availability in liquid substance feed tank is confirmed at step 531, and substance feed system 528 applies the substance to the product.

Referring to FIG. 13, an alternative fifth treatment 532 is described, in which the product is treated during transfer to packing using a vision system. At step 514, the product is loaded onto a conveyor. Transfer to packing is initiated at step 512, the vision system is checked to ensure it is on at step 533, and the product is detected at step 520. Treatment A/B system power 534 is on. Operation setting A 536 controls treatment A and Operating setting B 548 controls treatment B, such as turning the substance feed on/off and controlling the feed rate at steps 538 and 550. Liquid substance feed tanks A and B 542 supply the functional substances A and B applied to the product, and are controlled by operation settings 536 and 548. Substance availability in liquid substance feed tanks A and B is confirmed at step 544. The product is detected at step 540, and substance A feed system 546 applies substance A to the product. Defects on the product are detected at step 552, and substance B feed system 554 applies substance B to the product.

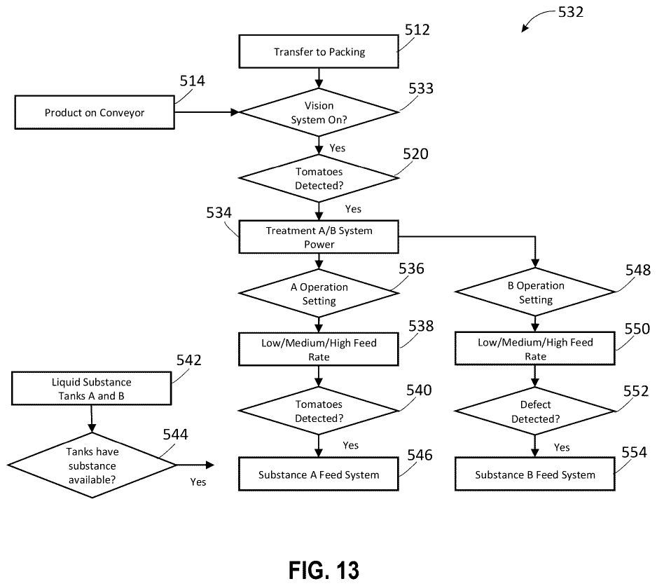

Referring to FIG. 14, a retreatment step 556 is described, in which the product is inspected and, if necessary, retreated. At step 560, the product is loaded onto a post treatment conveyor 558. The product is placed in inspection zone 562, and treatment system power 566 is on. Micro-organism sensor 570, treatment coverage sensor 572, and component measurement sensor 574 evaluate the product to determine whether the micro-organism, treatment coverage, and applied component levels, respectively, are within a target range. Operation setting 568 controls the system, such as turning the substance feed on/off and controlling the feed rate at step 578. Gaseous substance feed system 580 and liquid substance feed system 582 supply the functional substances applied to the product, and is controlled by operation setting 568. If the micro-organism, treatment coverage, and/or component levels are not within a target range, the product moves to retreatment zone 564 and gaseous substance feed system 580 and/or liquid substance feed system 582 initiate additional substance treatment to the product.

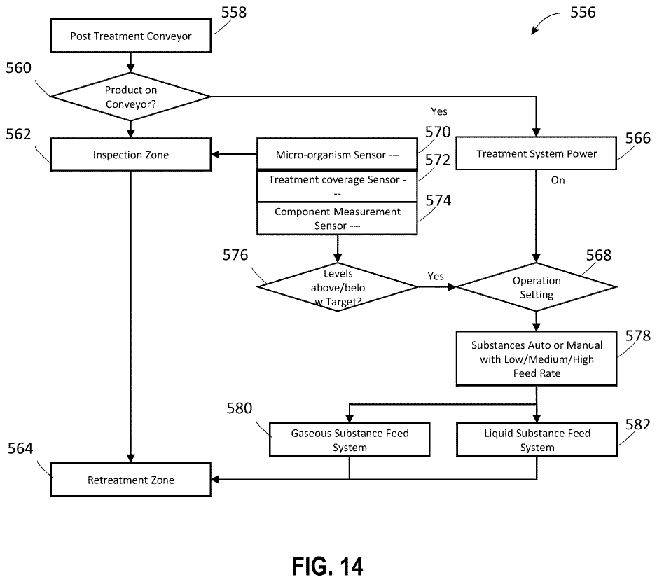

Referring to FIG. 15, a sixth treatment 584 is described, in which the product is treated during packing. At step 588, the product is loaded onto packing filler weigh scales. Packing machinery is initiated at step 586, the packing equipment is checked to ensure it is running at step 590, and the product is detected in weight scales at step 594. Treatment system power 592 is on. Operation setting 598 controls the application of sixth treatment 584, such as turning the substance feed on/off and controlling the feed rate at step 602. Treatment feed tank 606 supplies the functional substance applied to the product, and are controlled by operation setting 598. The product is transferred to its final packaging (such as clamshells, punnets, trays, etc.) at step 596. Substance availability treatment feed tank 606 is confirmed at step 608, and substance feed system 604 applies the substances to the product.

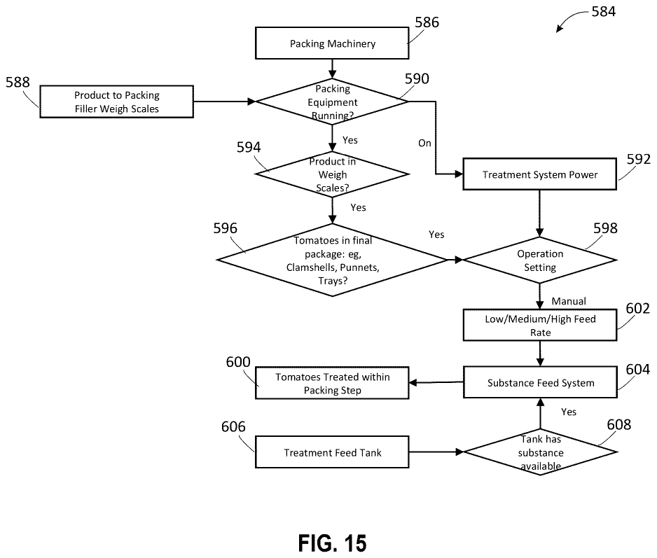

FIG. 16 is an overview of exemplary inputs and variables applied to treatments according to various embodiments of the present disclosure. Various factors or measured or evaluated including environmental factors 610, airborne fungal spore counts 612, crop conditions (fungal, bacterial, virus, spoilage) 614, quality assessments 616, crop conditions (pathogen or other contamination) 618, soil conditions 620, seasonal risk factors 622, soil amendments 624, treatment coverage levels 626, micro-organism levels 628, and component measurement levels 630. Artificial intelligence 632 and machine learning algorithms 634 may be applied to any of these factors to optimize and/or adjust any of the treatments according to various embodiments of the present disclosure.

### Examples

The following embodiments were selected as they represent the greatest need in the industry. However, the embodiments do not limit the invention, and the principles apply to a wide range of perishable products.

### Berries

Processing and treatment of berries is an unmet need. Berries are extremely sensitive to rapid mold growth, where any excess moisture or surface water present will result in reduced shelf life and accelerated spoilage. Thus, washing or sanitizing berries becomes extremely challenging due to the risk of rapid mold growth. Additionally, the berry industry needs new packaging that are both sustainable and reduce costs.

In view of the above unmet needs, embodiments of the present invention include a new and improved punnet, tray design, and inline method for cooling and substance treatments, lidding, weighing, labeling, and boxing/casing of products such as berries. The embodiments of the invention result in better and more efficient cooling dynamics, more effective and efficient directed substance treatments of the product, uses sensors, programming, feedback loops and management control processes to improve the current process, uses less energy for cooling, and generates less waste and a smaller environmental impact.

Substance treatment may be applied at various locations along the berry processing line. According to embodiments, a substance treatment may be applied to berries as an atomized and/or electrostatic spray with sanitizer on the berries prior to or during harvesting into punnet, as a substance and sanitizer application during transit or consolidation in truck/trailer/container in covered pallets, in a cooling in-feed conveyor, in initial zone of cooling tunnel or initial stage of cooling, in finishing zone of cooling tunnel or final stage of cooling, prior to or within punnet lid sealing machine, in modified atmosphere, or a combination thereof.

TABLE 1
Locations for berry substance application

| | | | | | | | Essen- | | Buff- | Min- | Aroma/ |
|---|---|---|---|---|---|---|---|---|---|---|---|
| Treatment | Berry Process and | | | Sani- | Surfac- | Emul- | tial | Humec- | ering | eral | Flavor |
| Location | substance application | Purpose | Carrier | tizer | tant | sifier | Oils | tant | Agent | Salts | Compounds |
| 1 | Fog or Atomized spray of | Control the growth | Ionized | X | X | | | | X | X | |
| | substance with sanitizer on | of mold on the fruit | Water | | | | | | | | |
| | product in punnet or | | | | | | | | | | |
| | container | | | | | | | | | | |
| 2 | Cover pallet, lightly seal, | Add sanitizer to | Air | X | | | X | | | | |
| | and inject substance | reduce micro- | | | | | | | | | |
| | treatments | organism counts | | | | | | | | | |
| 3 | substance pre-treatment of | Add sanitizer to | Ionized | X | X | | | | X | | |
| | product in punnet or | reduce micro- | Water | | | | | | | | |
| | container on conveyor | organism counts | | | | | | | | | |
| 4 | substance treatment in zone | recirculate sub- | Air | X | | X | X | | | | |
| | 1 of cooing tunnel or | stances focusing | Humidity | | | | | | | | |
| | initial stage of cooling | on sanitization | via Ion- | | | | | | | | |
| | | in air | ized Water | | | | | | | | |
| 5 | substance treatment in zone | recirculate sub- | Air | X | | X | X | X | | | |
| | 2 of cooing tunnel or | stances focusing | Humidity | | | | | | | | |
| | final stage of cooling | on enhanced | via Ion- | | | | | | | | |
| | | quality in air | ized Water | | | | | | | | |
| 6 | substance treatment within | durable sanitiation | Air | X | | X | X | X | | | X |
| | punnet lid sealing machine | substance and | | | | | | | | | |
| | | enhanced quality | | | | | | | | | |
| 7 | MAP Pallet prior to | reduce respiration | Nitrogen | X | | X | X | | | | X |
| | shipment | and senescence and | | | | | | | | | |
| | | ehance aromatics | | | | | | | | | |

According to an embodiment, a substance treatment is applied to picked berries, such as strawberries, raspberries, blackberries, blueberries and the like. According to embodiments, the substance may be a sanitizer. According to embodiments, the substance may be applied at the cooling cycle. According to embodiments, an additional substance treatment is applied in forced air cooling of berries in a controlled room. For example, the substance treatment may reduce dehydration during two (2) to four (4) hour cooling time while providing surface treatment to reduce mold spore counts. According to embodiments, the substance treatment reduces mold spore count. According to embodiments, the substance treatment reduces dehydration. According to embodiments, the substance is applied using nebulizing, fogging, or electrostatic spray nozzle.

A first substance treatment may be applied to berries at field level by using localized fog application with electrostatic charge. The electrostatic fog treatment will maximize fruit coverage, use minimal moisture, and result in minimal loss of material to waste in field. The substance treatment includes a sanitizer to immediately reduce mold and fungus microorganism counts, such as acidic water or peroxyacetic acid. The substance treatment also includes potassium sorbate mineral salt to stop growth of fungus and mold, and ascorbic acid to reduce decay in any cuts.

A second substance treatment may be a gaseous treatment delivered inside the pallet fitted with a protective covering for temporary containment of product and on location or in transit substance treatments, but a sealed enclosure is not required or desired (due to the field heat and berry temperature at this point in the process) when berries are packed just after harvest. The gaseous treatment sanitizes the berry surface, and may include ozone to immediately reduce mold and fungus microorganisms. The ozone is typically 0.03 ppm to 3 ppm level, although higher ppm ozone for shock treatment is possible. The substance treatment also includes essential oil to provide a durable functionality during the post-harvest period until delivery of the berries to the cooling and packing facility.

A third substance treatment may be a localized fog application with electrostatic charge of substance when the berries in punnet or crates are dumped onto conveyor prior to the cooling tunnel. The electrostatic treatment will maximize fruit coverage, use minimal moisture to inhibit mold, and result in minimal loss of material to waste in production area. The substance treatment includes a sanitizer to immediately reduce mold and fungus microorganisms, such as acidified water and peroxyacetic acid or a form of hydrogen peroxide. The substance treatment may also include ascorbic acid to reduce decay in cuts.

A fourth substance treatment may be a gaseous treatment delivered inside the cooling system, enabling recirculation of substances to contact berry surface during retention time in the cooling system. The gaseous treatment sanitizes the berry surface, and includes ozone to immediately reduce mold and fungus microorganisms. The ozone is typically 0.03 ppm to 3 ppm level, although higher ppm ozone for shock treatment is possible. The substance treatment also includes essential oil to provide additional antifungal function, and humidity via acidified or alkaline water vapor.

A fifth substance treatment may be a gaseous treatment delivered inside the cooling system, enabling recirculation of substances to contact berry surface during retention time in the cooling system. The gaseous treatment sanitizes the berry surface, and includes ozone to immediately reduce mold and fungus microorganisms. The ozone is typically 0.03 ppm to 3 ppm level, although higher ppm ozone for shock treatment is possible for example, but not limited to, in pulses or burst treatments. The substance treatment also includes essential oil to provide additional antifungal function, and humidity via acidified or alkaline water vapor.

A sixth substance treatment may be a gaseous treatment delivered into the final packaging after cooling, enabling substances to remain in contact with the berry surface during its shelf life. The gaseous treatment sanitizes the berry surface, and includes ozone to immediately reduce mold and fungus microorganisms. The ozone is typically 0.03 ppm to 3 ppm level, although higher ppm ozone for shock treatment is possible. The substance treatment also includes essential oil to provide additional antifungal function, glycerin as a humectant, berry essence for aroma, and butyl acetate for aroma and improved product appearance and anti-fungal activity.

A seventh substance treatment may be applied when the berries are packed on a pallet. The berries are packed on a pallet with a modified atmosphere as the berries are awaiting final shipment to customers. The substance treatment includes ozone, essential oil, and aromatic substances such as berry essence. The substance treatment reduces microorganism levels, reduces respiration and suppresses mold growth.

One or more of the above substance treatments may be used alone or in combination with each other. Additional substance treatments may be added to the production line as needed to achieve the desired effect.

### Proteins

According to an embodiment, a substance treatment is applied to uncooked proteins (meat, fish, foul, and vegetable proteins) prior to packaging. According to embodiments, the protein is cubed or ground meat. According to embodiments, the one or more substances are directly applied to the surface of a protein product via directed and electrostatically assisted treatment. According to an embodiment, the substance treatment comprises sanitizer solution, anti-fungal, essence, a barrier, or combinations thereof. According to embodiments, the substance treatment may include a solution base of ionized (acidified water) for sanitization, functional limonene from citrus oil for cleaning, and thyme oil and rosemary oil for anti-fungal. According to embodiments, the substance is applied using an electrostatic spray nozzle. According to embodiments, the substance is applied in a circular treatment zone or multiple zone treatment pass through apparatus, tube, or tunnel.

Substance treatments may be applied at various locations along an existing protein processing line. According to an embodiment, the substance is applied to incoming raw materials to avoid outside contamination. According to an embodiment, the substance may be applied after cutting and sorting of the protein to protect the newly exposed surfaces. According to an embodiment, the substance may be applied on a conveyor after cutting prior to packing. According to embodiments, the substance may be applied as a final barrier protection for surface contamination. According to embodiments, various substances may be applied at different points of the processing line.

TABLE 2
Locations for protein substance application

| | | | | | | | Essen- | | Buff- | Aroma/ |
|---|---|---|---|---|---|---|---|---|---|---|
| | Protein Process and | Treatment | | Sani- | Surfac- | Emul- | tial | Humec- | ering | Flavor |
| Step | substance application | Type | Carrier | tizer | tant | sifier | Oils | tant | Agent | Compounds |
| 1 | Process line conveyor with in- | Process | Water | X | X | | | | | |
| | coming raw materials-prevent | Aid | | | | | | | | |
| | outside contamination | | | | | | | | | |
| 2 | Conveyor after cutting and sorting- | Process | Water | X | X | | | | | |
| | new product surfaces exposed | Aid | | | | | | | | |
| | and protect from person or cutting | | | | | | | | | |
| | contamination | | | | | | | | | |
| 3 | Conveyor after cutting prior to | Residual | Water | X | | X | X | | | X |
| | packing | | | | | | | | | |
| 4 | Conveyor after cutting and prior | Residual | Water | X | | X | X | | | X |
| | to packing | | | | | | | | | |
| 5 | Added functional ingredients in | Residual | Water | X | | X | X | | | X |
| | existing spray | | | | | | | | | |
| 6 | Final barrier protection for | Residual | Air or | X | | X | X | | | X |
| | surface contamination | | Water | | | | | | | |
| 7 | Treat new cut surfaces on lower | Residual | Air or | X | | X | X | | | X |
| | quality content | | Water | | | | | | | |

### Vegetables

According to an embodiment, a substance treatment is applied to vegetables. According to an embodiment, substance treatment is applied to leafy vegetables, such as lettuce, spinach, kale, chard, arugula, and the like. According to embodiments, the leafy vegetables are salad greens (i.e., “triple washed” bagged lettuce). According to an embodiment, the substance is applied using an electrostatic spray nozzle. According to embodiments, the electrostatic spray nozzle is located at a conveyor feed belt discharge to the dryer. According to embodiments, the electrostatic spray nozzle is located in the centrifugal dryer. According to embodiments, the one or more substances are applied to the leafy vegetable via directed and electrostatically assisted treatment. According to embodiments, the substance is applied using an electrostatic spray nozzle.

Substance treatments may be applied at various locations along an existing vegetable processing line. According to an embodiment, the substance is applied to incoming raw materials to avoid outside contamination. According to an embodiment, the substance may be applied after cutting to protect the newly exposed surfaces. According to embodiments, substance treatment may be applied on a process line conveyor with cut lettuce, as nitrogen is added to the chamber and fills bins, added as a local injection of components to a bin as it is sealed, added to or within the cutting machine, added to flume or belt wash system, added at feed or inside drying machine, added as a final treatment on conveyor or as bin is discharged onto packing equipment weigh scales, or a combination thereof. According to embodiments, various substances may be applied at different points of the processing line.

TABLE 3
Locations for leafy green substance application

| | | | | | | Essen- | | Buff- | Min- | Aroma/ |
|---|---|---|---|---|---|---|---|---|---|---|
| | Lettuce Process and | Treatment | | Sani- | Surfac- | tial | Humec- | ering | eral | Flavor |
| Step | substance application | Type | Carrier | tizer | tant | Oils | tant | Agent | Salts | Compounds |
| 1 | Process line conveyor with | Process | Water | X | X | | | X | X | |
| | cut lettuce | Aid | | | | | | | | |
| 2 | Apply functional components | Process | Nitrogen | X | | | | | | |
| | as N2 is added to chamber | Aid | | | | | | | | |
| | and fills bins | | | | | | | | | |
| 3 | Local injection of | Process | Nitrogen | X | | X | | | | |
| | components to a bin as it is | Aid | | | | | | | | |
| | sealed. | | | | | | | | | |
| 4 | Applied in the cutting | Process | Water | X | X | | | | | |
| | machine itself | Aid | | | | | | | | |
| 5 | Added functional ingredients | Process | Water | X | X | | | | | |
| | to flume or belt wash system | Aid | | | | | | | | |
| 6 | Added at feed or inside | Residual | Air or | X | | X | | X | | X |
| | drying machine | | Water | | | | | | | |
| 7 | Final treatment on conveyor | Residual | Air | | | X | X | X | X | X |
| | or as bin is discharged onto | | | | | | | | | |
| | packing equipment weigh | | | | | | | | | |
| | scales | | | | | | | | | |

### Fresh Tomatoes

Processing and treatment of tomatoes, including grape and cherry tomatoes, is an unmet need. Presently, the only treatment that, for example, cherry tomatoes receive is a spray wash with brushing to remove surface debris. Cherry tomatoes are generally handpicked and have bruising, picking scar and/or ripeness defects. The surface defects are vulnerable to mold/decay. Tomatoes contain spoilage microorganisms, such as Pseudomonads, yeast, mold, Bacillus, Erminia, Xanthomonas, and Clostridium spp. Tomatoes have also been recalled for Salmonella contamination. Tomatoes are also especially susceptible to dehydration and cross-contamination during cooling.

In view of the above unmet needs, embodiments of the present invention reduce micro-organism counts and enhance health of tomato skin and surface defects by identifying points of tomato processing to incorporate novel substance treatments. Substance treatments may be applied at various locations along an existing tomato processing line. According to embodiments, a substance treatment may be applied to tomato plants in the greenhouse, a spray wash prior to cooling, a spray wash and ozone treatment within the cooling tunnel, an electrostatic spray treatment just prior to a wash step, an electrostatic spray as tomatoes are conveyed to packing, in the cold storage room to prevent mold on refrigeration and cooler surface, in modified atmosphere (MAP) pallet, or a combination thereof. According to embodiments, the substance treatment may be vision technology assisted for treatment of defects.

TABLE 4
Locations for tomato substance application

| Treatment | Tomato Process and | | | |
|---|---|---|---|---|
| Location | substance application | Description | Process | Decision |
| 1 | Pre-harvest treatment | Fog treatment of sanitizer and/or | Localized fogging of | Surface coating of the substance on the leaves and |
| | of tomato plant | essential oil to the plant to prevent | electrostatic charged | fruit provides a barrier to development of fungus |
| | | fungus and mold development | substance at the plant | and mold. Minimal residual moisture desired. |
| | | | in the greenhouse | |
| 2 | Add electrostatic spray | Washing chamber with electrostatic | Tomatoes in harvest | Receiving dock will have limited ability to drain |
| | wash with ionized | spray to get initial surface coating | trays, stacked on | high volumes of liquid, so only a surface treatment |
| | water prior to cooling | of sanitizer | pallet on receiving | with less expensive sanitizer substance. |
| | | | dock | |
| 3 | Add spray wash within | During cooling, use automatic | Pallets in high air | Cool room concenrates air flow around pallets. |
| | cooling tunnel | software program or manual process | flow cooling room | During the cooling time, able to apply sanitizer |
| | Ozone Treatment | settings to apply sanitizer substance | | in a way it will reach the tomato surfaces while |
| | | for continued contact with tomato | | also maintaining a clean room. High room volume |
| | | surfaces | | dictates only use of a less expensive sanitizer |
| | | | | substance. |
| 4 | Add electrostatic spray | Highly active sanitizer to | Tomatoes entering | Some microorganisms are only effected by highly |
| | treatment just prior to | significantly reduce microorganism | the wash tunnel | active sanitizer. “Burst” application followed by |
| | current wash step | counts; | | low active sanitizer wash provides the intense |
| | | | | sanitize step and then is diluted to prevent any |
| | | | | damage to the tomatoes |
| 5a | Electrostatic spray on | During the transfer via conveyor to | Tomatoes within a | Intimate and last location to treat tomatoes. |
| | conveyor to packing | be packed, electrostatic spray light | tunnel or on exposed | Treatment to have immediate and longer lasting |
| | | surface treatment | conveyor in | efficacy. Intimacy enables optimal use and |
| | | | Refrigerated | minimal waste of more expensive substances. |
| | | | Warehouse | |
| 5b | Electrostatic spray | | | |
| | using Vision Assist | | | |
| 6 | In the cold storage | Use program settings. Inject at inlet | Sanitizers work on | Careful use of gas sanitizer like ozone and liquid |
| | room, during facility | to recirculating air fans to treat | microorganisms on | substance like essential oil to maintain clean |
| | sanitation period | heat exchange surface and distribute | refrigeration and | ceiling, walls, and equipment surfaces during |
| | Ozone Treatment | throughout cold room | wall surfaces | operation. Can be directed near pallet storage. |
| 7 | MAP Pallet prior to | MAP Prior art; wrap/seal the product | Pallet wrapping | All substances applied within the sealed enclosure. |
| | shipment | within the pallet; apply N₂ and | system in | Substances can have an immediate and longer |
| | | other substance treatment. | Refrigerated | lasting efficacy. Cost effective use of aromatic |
| | | | Warehouse | substances. |

TABLE 5
Locations for tomato substance application

| | | | | | | | Essen- | | Buff- | Min- | Aroma/ |
|---|---|---|---|---|---|---|---|---|---|---|---|
| Treatment | Tomato Process and | | | Sani- | Surfac- | Emul- | tial | Humec- | ering | eral | Flavor |
| Location | substance application | Purpose | Carrier | tizer | tant | sifier | Oils | tant | Agent | Salts | Compounds |
| 1 | Pre-harvest treatment | Control the growth | Air | X | X | X | X | | | | |
| | of tomato plant | of mold on the | | | | | | | | | |
| | | leaves and tomatoes | | | | | | | | | |
| 2 | Add spray wash with | Add sanitizer to | Water | X | X | | | | | | |
| | ionized water | reduce micro- | | | | | | | | | |
| | prior to cooling | organism counts | | | | | | | | | |
| 3 | Add spray wash within | Add sanitizer to | Water | X | X | | | | X | | |
| | cooling tunnel | reduce micro- | | | | | | | | | |
| | | organism counts | | | | | | | | | |
| | Ozone Treatment | Add sanitizer to | Recircu- | X | | | | | | | |
| | | reduce micro- | lating | | | | | | | | |
| | | organism counts | Air | | | | | | | | |
| 4 | Add electrostatic spray | Intense or high | Water | X | X | X | X | | | | |
| | treatment just prior to | active sanitation | | | | | | | | | |
| | current wash step | treatment moments | | | | | | | | | |
| | | before tomatoes | | | | | | | | | |
| | | are washed and | | | | | | | | | |
| | | rinsed | | | | | | | | | |
| 5a | Electrostatic spray on | Add sanitizer to | Air | X | | X | X | X | X | | |
| | conveyor to packing | reduce micro- | | | | | | | | | |
| | | organism counts; | | | | | | | | | |
| | | humectant and | | | | | | | | | |
| | | buffering agent | | | | | | | | | |
| | | to reduce | | | | | | | | | |
| | | dehydration and | | | | | | | | | |
| | | senescence | | | | | | | | | |
| 5b | Electrostatic spray | Add sanitizer to | Air | X | | X | X | X | X | X | |
| | using Vision Assist | reduce micro- | | | | | | | | | |
| | | organism counts; | | | | | | | | | |
| | | humectant and | | | | | | | | | |
| | | buffering agent | | | | | | | | | |
| | | to reduce | | | | | | | | | |
| | | dehydration and | | | | | | | | | |
| | | senescence | | | | | | | | | |
| 6 | In the cold storage | Reduce cross- | Water | X | | X | X | | | | |
| | room, during facility | contamination | | | | | | | | | |
| | sanitation period | | | | | | | | | | |
| | Ozone Treatment | Add sanitizer to | Air | X | | | | | | | |
| | | reduce micro- | | | | | | | | | |
| | | organism counts | | | | | | | | | |
| 7 | MAP Pallet prior to | Reduce respiration | Nitrogen | X | | X | X | | X | | X |
| | shipment | and senescence and | | | | | | | | | |
| | | ehance aromatics | | | | | | | | | |

TABLE 6
Locations for pre-cut tomato substance application

| | | | | | | | Essen- | | Buff- | Aroma/ |
|---|---|---|---|---|---|---|---|---|---|---|
| | Tomato Process and | Treatment | | Sani- | Surfac- | Emul- | tial | Humec- | ering | Flavor |
| Step | substance application | Type | Carrier | tizer | tant | sifier | Oils | tant | Agent | Compounds |
| 1 | Apply in the slicing machine to | Process | Water | X | X | | | | X | |
| | surface treat the slices and the | Aid | | | | | | | | |
| | slicing blades. | | | | | | | | | |
| 2 | Apply to the dices following the | Residual | Air or | X | | | X | | X | |
| | flume as they release excess water | | Water | | | | | | | |
| | and move to packing steps. | | | | | | | | | |
| 3 | Apply in the weigh scales to sanitize | Residual | Air or | X | | | X | | X | |
| | surface | | Water | | | | | | | |
| 4 | Apply on the top of the diced | Residual | Air or | X | | | X | | X | |
| | tomatoes in the tray before the film | | Water | | | | | | | |
| | seal is applied. | | | | | | | | | |

According to an embodiment, substance treatment may be applied to fresh tomatoes, including pre-cut fresh tomatoes to reduce mold and other pathogens. According to an embodiment, the tomatoes are cherry or grape tomatoes. According to an embodiment, the tomatoes are roma or round tomatoes. According to embodiments, the substance is a sanitizer. According to embodiments, the one or more substances are applied through an electrostatic spray nozzle.

According to embodiments, the substance treatment may be applied after harvest. According to embodiments, the substance treatment may be applied after a spray wash. According to embodiments, the spray wash may be changed to an electrostatic spray and ionized water or ionized liquid sanitizer with additional treatment components. According to embodiments, the one or more substances may be added into final rinse and dry step. According to embodiments, the one or more substances may be applied after handling and processing prior to packing. According to embodiments, the one or more substances may be applied prior to applying a wax. According to embodiments, the one or more substances may be applied in the ripening room to reduce mold count in cold storage. According to embodiments, the one or more substance treatments may be applied in the cold storage room to prevent mold on refrigeration and cooler surfaces.

According to embodiments, the one or more substances may be applied in the slicing machine to surface treat the slices and the slicing blade. According to embodiments, the one or more substances may be applied to the dices following the fume as they release excess water and move to packing steps. According to embodiments, the one or more substances may be applied to the weigh scales to sanitize the surfaces. According to embodiments, the one or more substances may be applied on the top of the diced tomatoes in the tray before the film seal is applied.

A first substance treatment may be applied as a localized fog application with an electrostatic charge on tomato plants in the greenhouse pre or during harvest. The electrostatic charge of the substance will maximize plant and fruit coverage, use minimal moisture, and provide for minimal loss of material to general warehouse space. The substance treatment includes a sanitizer to immediately reduce mold and fungus microorganism counts, such as peroxyacetic acid. The substance treatment also includes a durable antifungal, that is, an antifungal that will remain on the surface of the tomato to prevent mold and fungus from developing, such as essential oil and potassium sorbate mineral salt. The substance treatment is applied dry or mostly dry to avoid additional fungus and mold growth issues.

A second substance treatment may be a spray wash with a substance solution applied to the harvested tomatoes prior to cooling. The second substance treatment applies a sanitizer and surfactant to the tomato surface. The substance treatment includes a sanitizer to immediately reduce mold and microorganism counts, such as peroxyacetic acids. The substance treatment also includes a surfactant, such as potassium oleate. The surfactant will enhance efficacy of the sanitizer and further sanitizing steps.

A third substance treatment may be applied in an enclosed tunnel during cooling of the tomatoes. The treatment is a spray wash atomized or volatilized in recirculating air. Ozone is distributed in the recirculating air. A software based program leverages feedback from sensors to control the substance and ozone feed rates. Feedback includes detection and measurement of microorganisms on the tomatoes, product temperature, substance and ozone feed rates, and ozone levels in the recirculating air. The substance treatment includes a sanitizer to immediately reduce mold and microorganism counts, such as ozone and peroxyacetic acid. Additional functional substances include potassium oleate as a surfactant and a buffering agent.

The treatment system is integrated with the cooling process. Treatment function control is slave to the cooling room operation such that if the doors are open and/or the air cooling system is not operating, then the treatment system is off. Once the doors to the cooling room are closed and the cooling process is turned on, then the treatment system also powers up. Program settings may be manual or auto. Auto (programmed) settings for temperature and microorganism reduction will determine the amount and sequence of substance and ozone during cooling. Optional manual settings for treatment include ozone only, substance only, or a combination of ozone and substance with low, medium, or high feed rates. For auto control, the system provides the treatment until the temperature and microorganism targets are achieved. The programmed treatment turns off automatically. The manual controlled treatment turns off if the doors are opened or the cooling system is turned off. The operator is able to observe the key indicators of the process. Alarms are present if the supply of substance or any process indicator is out of target range. A record of the treatment is able to be retrieved. This would support the facility HACCP program.

A fourth substance treatment may be applied as an electrostatic spray of tomatoes as they are conveyed just prior to a wash and dry step. The electrostatic spray treatment uses a very strong sanitizer just before the current wash step to maximize coverage and minimize the quantity of substance used to avoid overspray and waste. The substance treatment includes peroxygen bleach, an intense sanitizer to reduce resistant microorganisms. Additional functional substances include potassium oleate as a surfactant, essential oil, and a buffering agent. Peroxygen bleach is generally not used despite being an effective sanitizer because it will damage a product such as a tomato. However, by following the application of peroxygen bleach with a wash and dry step, the dwell time of peroxygen bleach may be carefully controlled to minimize any damage to the tomatoes.

Treatment system control is slave to the conveyor and washing operation; if the conveyor or wash system is off, then the treatment system is off. Once the conveyor and wash system are turned on, then the treatment system powers up. Operator sets low/medium/high feed settings. Low/medium/high is determined by QA product inspections for defects and microorganisms and recent shipping results. Once the sensor detects tomatoes are present, then the system provides the treatment flow rate selected (low/medium/high). The treatment turns off if tomatoes are not present or if the conveyor or wash system are turned off. The operator is able to observe the flow rate and pressure of the treatment. The operator is alerted if the treatment container, placed on a weigh load cell, goes below the set point. A record of the treatment is able to be retrieved. This would support the facility HACCP program.

A fifth substance treatment may be applied as an electrostatic spray of tomatoes as they are conveyed just after the wash and dry step, on their way to packing. The electrostatic spray treatment uses a sanitizer with components to provide durable protection to the tomato surface just before the packing step. Vision technology enables directed treatment of defects on the tomato surface. The substance treatment is applied mostly dry to minimize the remaining surface moisture. The substance treatment includes peroxyacetic acid for an additional log reduction of mold/fungus counts. Additional functional substances include essential oil, glycerin, potassium sorbate, and potassium bicarbonate.

The treatment system control is slave to the conveyor operation; if the conveyor is off, then the treatment system is off. Once the conveyor is turned on, then the treatment system powers up. Operator sets low/medium/high feed settings. Low/medium/high is determined by QA product inspections for defects and microorganisms, and recent shipping results. Once the sensor detects tomatoes are present, then the system provides the treatment flow rate selected (low/medium/high). The treatment turns off if tomatoes are not present or if the conveyor is turned off. The operator is able to observe the flow rate and pressure of the treatment. The operator is alerted if the treatment container, placed on a weigh load cell, goes below the set point. A record of the treatment is able to be retrieved. This would support the facility HACCP program.

A vision system can be integrated into the system to detect defects on the surface of the tomato and apply an additional substance to the defect. The treatment system control is slave to the conveyor and Vision system operation; if the conveyor and Vision system are off, then the treatment system is off. Once the conveyor and Vision or Sensor System are turned on, then the treatment system powers up. Operator sets low/medium/high feed settings for both treatment A and B. Low/medium/high is determined by QA product inspections for defects and microorganisms, and recent shipping results. Once the sensor detects tomatoes are present, then the system provides the treatment A flow rate selected (low/medium/high). If the Vision system detects a defect on a tomato, then the on/off valve for the treatment B nozzle applies to the defective tomato. The treatment turns off if tomatoes are not present or if the conveyor is turned off. The operator is able to observe the flow rate and pressure of the treatment. The operator is alerted if the treatment container, placed on a weigh load cell, goes below the set point. A record of the treatment is able to be retrieved. This would support the facility HACCP program.

A sixth substance treatment may be applied as an atomized substance spray on the inlet of the refrigerator in the holding/processing room. Ozone is dispersed at the outlet of the refrigeration equipment to be dispersed throughout the process room. A software program executes controlled release of the substance and ozone. The substance treatment includes peroxyacetic acid and ozone to reduce microorganisms on the surface. Additional functional substances include a surfactant and essential oil.

The treatment system control is slave to the cooling equipment operation; if the cooling units are off, then the treatment system is off. The system can be turned on to operate during production or when the facility is idle. Program setting selected for ozone only, substance only, or a combination of ozone and substance. Operator sets low/medium/high feed setting and timer. Then the system provides the treatment flow rate and for the time set. Program setting and low/medium/high determined by QA and Operations for intended purpose, e.g., heavy sanitization or maintenance levels. The program can regulate the amount, sequence, and time of the treatments. The treatment turns off if the cooling equipment shuts off or by Operations or QA. The operator is able to observe the flow rate and pressure of the treatment. The operator is alerted if the treatment container, placed on a weigh load cell, goes below the set point. A record of the treatment is able to be retrieved. This would support eh facility HACCP program.

A seventh substance treatment may be applied when the tomatoes are packed on a pallet. The tomatoes are packed on a pallet with a modified atmosphere as the tomatoes are awaiting final shipment to customers. The substance treatment includes ozone, essential oil, and aromatic substance 3-hexenal, 4-methyl furan. The substance treatment reduces microorganism levels and reduce respiration and suppress mold growth.

One or more of the above substance treatments may be used alone or in combination with each other. Additional substance treatments may be added to the production line as needed to achieve the desired effect.

Table 7 shows results of sanitization and MAP treatment according to embodiments of the invention, indicating reduced defects due to shrivel, rot, yeast, and mold/decay.

TABLE 7
Results

| | | Culled | | | | | | Culled | | | | |
|---|---|---|---|---|---|---|---|---|---|---|---|---|
| | | and | Packed- | Day | Day | Day | | and | Packed- | Day | Day | Day |
| BEFORE | Harvest | Cooled | Day 0 | 7 | 14 | 21 | AFTER | Cooled | Day 0 | 7 | 14 | 21 |
| Temperature | 80 F. | 50 F. | | | | | Temperature | 50 F. | | | | |
| Basis Weight | 100% | 95% | 95% | 90% | 85% | 80% | Basis Weight | 98% | 98% | 95% | 92% | 88% |
| Color | | | | | | | Color | | | | | |
| Over-ripe/ | 5% | 2% | 2% | 4% | 8% | 16% | Over-ripe/ | 2% | 2% | 3% | 6% | 12% |
| Soft | | | | | | | Soft | | | | | |
| % 5-6 | 75% | 85% | 85% | 88% | 92% | 84% | % 5-6 | 85% | 85% | 87% | 89% | 88% |
| % <5 | 20% | 13% | 13% | 8% | 0% | 0% | % <5 | 13% | 13% | 10% | 5% | 0% |
| % Defects | | | | | | | % Defects | | | | | |
| Bruising | 3% | 2% | 4% | 6% | 6% | 6% | Bruising | 2% | 4% | 6% | 6% | 6% |
| Cuticle Pick | 10% | 5% | 5% | 5% | 5% | 5% | Cuticle Pick | 5% | 5% | 5% | 5% | 5% |
| Scar | | | | | | | Scar | | | | | |
| Scar | 2% | 2% | 2% | 2% | 2% | 2% | Scar | 2% | 2% | 2% | 2% | 2% |
| Shriveling | 1% | 0.5% | 0.5% | 1% | 4% | 8% | Shriveling | 0.5% | 0.5% | 0.5% | 2% | 4% |
| Splits | 2% | 1% | 1% | 1% | 2% | 4% | Splits | 1% | 1% | 1% | 2% | 2% |
| Rot | 0.5% | 0.1% | 0.1% | 0.2% | 0.5% | 1% | Rot | 0.1% | 0.1% | 0.1% | 0.2% | 0.5% |
| Yeast | 0.5% | 0.1% | 0.1% | 0.2% | 2% | 4% | Yeast | 0.1% | 0.1% | 0.1% | 0.2% | 1% |
| Mold/Decay | 0.5% | 0.1% | 0.1% | 0.2% | 2% | 8% | Mold/Decay | 0.1% | 0.1% | 0.1% | 0.2% | 1% |
| Sub-total | 20% | 11% | 13% | 16% | 24% | 38% | Sub-total | 11% | 13% | 15% | 17% | 22% |

### Avocados

According to an embodiment, substance treatment is applied to the exterior of avocados to reduce pathogens on the surface. According to embodiments, the substance is a sanitizer. According to embodiments, the one or more substances are applied through an electrostatic spray nozzle.

Substance treatments may be applied at various locations along an existing avocado processing line. According to embodiments, the substance treatment may be applied after harvest. According to embodiments, the substance treatment may be applied after a spray wash. According to embodiments, the spray wash may be changed to an electrostatic spray and ionized water with additional treatment components. According to embodiments, the one or more substances may be added into final rinse and dry step. According to embodiments, the one or more substances may be applied after handling and processing prior to packing. According to embodiments, the one or more substances may be applied before applying a wax. According to embodiments, the one or more substances may be applied in the ripening room to reduce mold count in cold storage. According to embodiments, the one or more substance treatments may be applied in the cold storage room to prevent mold on refrigeration and cooler surfaces.

According to embodiments, the substance may comprise a functional diluent or solvent, including but not limited to ionized water, ionized liquid sanitizer, acidified water, ethanol, isopropyl alcohol, nitrogen, ozone and the like. According to embodiments, the substance may comprise a sanitizer, including but not limited to chlorine dioxide, hydrogen peroxide, peracetic acid, ozone and the like. According to embodiments, the substance treatment may comprise an essential oil, including but not limited to lemon oil, orange oil, grapefruit oil, rosemary oil, sunflower oil, other fruit-derived oils, tea tree oil, cinnamon oil and the like. According to embodiments, the substance may comprise a surfactant including but not limited to potassium oleate, sodium dodecyl sulfate (SDS) and the like. According to embodiments, the substance may comprise a humectant including but not limited to sorbitol, glycerin, glycerol and the like. According to embodiments, the substance may include buffering agents and/or mineral salts including but not limited to ascorbic acid, citric acid, sodium bicarbonate, calcium phosphate and the like. According to embodiments, the substance may include aroma and flavor compounds including but not limited to esters, linear terpenes, cyclic terpenes, alcohols, aldehydes, esters, ketones, lactones, thiols and the like.

TABLE 8
Locations for avocado substance application

| | | | | | | | Essen- | | Buff- | Aroma/ |
|---|---|---|---|---|---|---|---|---|---|---|
| | Avocado Process and | Treatment | | Sani- | Surfac- | Emul- | tial | Humec- | ering | Flavor |
| Step | substance application | Type | Carrier | tizer | tant | sifier | Oils | tant | Agent | Compounds |
| 1 | Process line spray wash step | Process | Water | X | X | | | | | |
| | | Aid | | | | | | | | |
| 2 | Process line final rinse and dry step | Residual | Water | X | | X | X | X | X | |
| 3 | After handling and processing prior | Residual | Water | X | | X | X | X | X | |
| | to packing | | | | | | | | | |
| 4 | In the cold storage room | Residual | Water | X | | X | X | | | |
| | MAP Pallet prior to | Residual | Nitrogen | X | | X | X | | X | X |
| | shipment | | | | | | | | | |

### Floral Products

Processing and treatment of fresh-cut flowers such as roses is an unmet need. For example, the vast majority of roses come from Colombia, where they are harvested, packed and shipped to North America, where they are held in various facilities before being dispatched to customers across the country. Fresh-cut flowers are highly susceptible to moisture loss and dehydration, but will also mold with moisture and humidity. As such, air transport is necessary, but expensive.

In view of the above unmet needs, embodiments of the present invention provide fungistatic substance treatment for mold reduction and/or a surface coating/wax/surfactant ionic or non-ionic for moisture loss prevention. According to embodiments, substance treatment may include solution bases use ionized (acidified water) for sanitization, functional terpene from citrus oil for cleaning, tea tree oil for anti-fungal, and cinnamon oil for anti-mold. According to embodiments, a substance treatment may be applied to cut flowers prior to or at harvest, in cooling chamber, after handling and processing prior to packing, in the cold storage room to prevent mold on refrigeration and cooler surfaces, and as the flowers are unpacked and placed in display cases. According to embodiments, the floral products may be roses. According to embodiments, a substance treatment may be applied to roses in the greenhouse, to the cut flowers as harvested in carts, to flower ends as they are de-thorned and staged on chutes or in chute tunnels, to stems and leaves in chute tunnel, through packing as they are cooled, and in modified atmosphere stack.

TABLE 9
Locations for floral substance application

| | | | | | | | Essen- | | Buff- | Aroma/ | |
|---|---|---|---|---|---|---|---|---|---|---|---|
| | Floral Process and | Treatment | | Sani- | Surfac- | Emul- | tial | Humec- | ering | Flavor | Plant |
| Step | substance application | Type | Carrier | tizer | tant | sifier | Oils | tant | Agent | Compounds | Nutrition |
| 1 | Apply to cut flowers as prior to | Process | Water | X | | X | X | X | X | | X |
| | or as harvested | Aid | | | | | | | | | |
| 2 | Apply functional components | Residual | Water | X | | X | X | X | | | |
| | into cooling chamber | | | | | | | | | | |
| 3 | Apply after handling and | Residual | Water | X | | X | X | X | X | X | X |
| | processing prior to packing | | | | | | | | | | |
| 4 | Apply in the cold storage room | Residual | Water | X | | X | X | X | X | X | |
| | to prevent mold on | | | | | | | | | | |
| | refrigeration and cooler | | | | | | | | | | |
| 5 | Apply treatment as unpacked | Residual | Water | X | | X | X | X | X | X | X |
| | and placed in display case | | | | | | | | | | |

TABLE 10
Locations for rose substance application

| | | | | | | | Essen- | | Buff- | Aroma/ | |
|---|---|---|---|---|---|---|---|---|---|---|---|
| | Floral Process and | Treatment | | Sani- | Surfac- | Emul- | tial | Humec- | ering | Flavor | Ethylene |
| Step | substance application | Type | Carrier | tizer | tant | sifier | Oils | tant | Agent | Compounds | Scavenger |
| 1 | Apply with electrostatic | Process | Acidified | X | | X | X | X | X | | X |
| | fogging in greenhouse | Aid | or Alkaline | | | | | | | | |
| | | | Water | | | | | | | | |
| 2 | Apply to cut flowers as | Process | Acidified | X | | X | X | X | X | | X |
| | harvested in carts | Aid | or Alkaline | | | | | | | | |
| | | | Water | | | | | | | | |
| 3a | Zone 1: Apply to flower ends as | Process | Acidified | X | | | | | X | | X |
| | they are dethorned and staged | Aid | or Alkaline | | | | | | | | |
| | on chutes or in chute tunnel | | Water | | | | | | | | |
| 3b | Zone 2: Apply to flower ends as | Process | Air | | | | X | X | | X | |
| | they are dethorned and staged | Aid | Nebulizer | | | | | | | | |
| | on chutes or in chute tunnel | | | | | | | | | | |
| 3c | Zone 3: Apply to flower stems | Process | Acidified | X | | | | X | X | | X |
| | and leaves on chute or in | Aid | or Alkaline | | | | | | | | |
| | chute tunnel | | Water | | | | | | | | |
| 4 | Apply through packing as they | Process | Air | | | | X | | | | X |
| | are cooled | Aid | | | | | | | | | |
| 5 | MAP for pallets | Residual | Industrial | X | | | X | X | | X | X |
| | | | Gas | | | | | | | | |

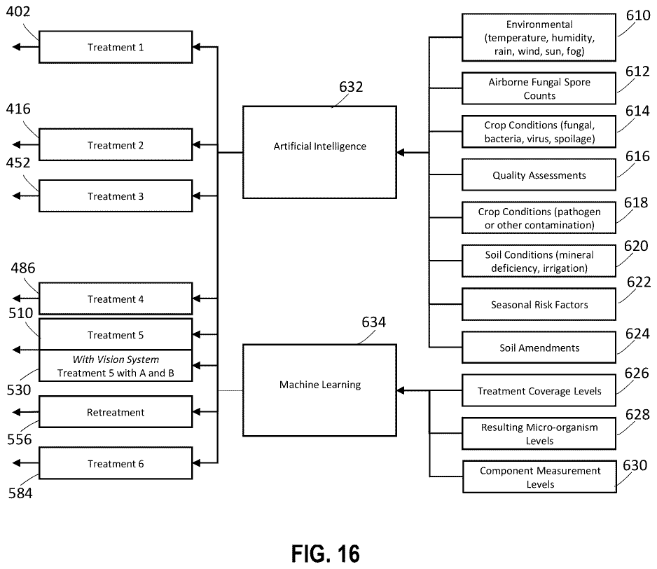

Referring to FIG. 17, substance treatment may be applied to floral products 700 during chute cooling and/or conditioning tunnel. Zone 1 substance treatment may include spectral reflectance measurement, and electrostatic fog application with acidified or alkaline water sanitizer, a humectant, and an ethylene scavenger. Zone 2 substance treatment may include nebulized essential oil application and an aroma essence. Zone 3 substance treatment may include a humectant and an ethylene scavenger.

According to embodiments, cut flowers such as roses can be wrapped in functionally treated sheet material as they are packed into cartons. According to embodiments the treated sheet material can be pulp based or paper materials, woven and non-woven materials, or foils that are sprayed with, coated, impregnated, laminated, or have printed on functional substances; wherein this treated sheet material can be used to wrap the perishable products, inserted into the punnet or package with the perishable product, or wrap around a stack of punnets, or wrap around perishable products in a master container, or wrap around products stacked on a pallet.

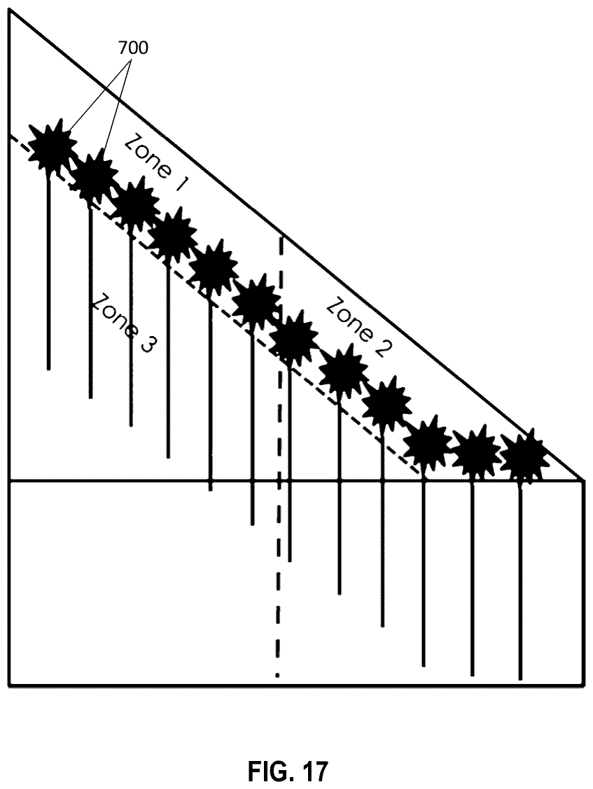

In addition, the palletized stacks of cartons can be further wrapped using the functionally treated sheet material. See FIGS. 18A and 18B which illustrate packing or wrapping floral products 700 with functionally treated sheet material 701.

### Cannabis

According to embodiments, substance treatment may be applied to cannabis or other perishable food products to improve the value and quality, and to prevent mold. According to embodiments, substance treatment is applied using electrostatic spray nozzle. According to embodiments, substance treatment is applied using nebulizing diffuser. According to embodiments, substance treatment includes sanitizers. According to embodiments, substance treatment includes terpene and/or terpenoid compounds. According to embodiments, substance treatment includes anti-fungal compounds.

Substance treatments may be applied at various locations along an existing cannabis or hemp processing line. According to embodiments, the one or more substances are applied after harvesting. According to embodiments, substance treatment is applied in a cold room. According to embodiments, substance treatment occurs in a fog tent or pass through apparatus. According to embodiments, substance treatment occurs in a greenhouse. According to embodiments, substance treatment occurs before drying. According to embodiments, substance treatment occurs before packing. According to embodiments, substance treatment is applied to plants prior to harvesting. According to embodiments, more than one substance treatment may be applied at different points of processing.

According to embodiments, substance treatment is applied to hemp fiber. According to embodiments, substance treatment is applied to hemp seed. According to embodiments, substance treatment is applied to hemp product or oil.

According to embodiments, the one or more substances may be applied to the seed surface on the harvest machine. According to embodiments, the one or more substances may be applied to the seed in storage containers. According to embodiments, the one or more substances may be applied on equipment and hulled seeds to prevent mold. According to embodiments, the one or more substances may be applied after seed oil press to prevent oil from oxidizing. According to embodiments, the one or more substances may be applied to the seed cake to prevent mold and oxidation. According to embodiments, the one or more substances may be applied to harvested hemp stalks to prevent mold.

According to embodiments, the substance may comprise a functional diluent or solvent, including but not limited to ionized water, acidified water, ethanol, isopropyl alcohol, nitrogen, ozone and the like. According to embodiments, the substance may comprise a sanitizer, including but not limited to chlorine dioxide, hydrogen peroxide, peracetic acid, ozone and the like. According to embodiments, the substance treatment may comprise an essential oil, including but not limited to lemon oil, orange oil, grapefruit oil, rosemary oil, sunflower oil, other fruit-derived oils, tea tree oil, cinnamon oil, eucalyptus oil and the like. According to embodiments, the substance may comprise a surfactant including but not limited to potassium oleate, sodium dodecyl sulfate (SDS) and the like. According to embodiments, the substance may comprise a humectant including but not limited to sorbitol, glycerin, glycerol and the like. According to embodiments, the substance may include buffering agents and/or mineral salts including but not limited to ascorbic acid, citric acid, sodium bicarbonate, calcium phosphate and the like. According to embodiments, the substance may include aroma and flavor compounds including but not limited to esters, linear terpenes, cyclic terpenes, alcohols, aldehydes, esters, ketones, lactones, thiols and the like.

### Packaging and Labeling

According to an embodiment, the packaging for the product, such as the perishable product, may be a system, method and design to achieve completely recyclable clear plastic consumer product packaging. The packaging may include a punnet, cup, bowl, clam shell, or “naked packaging.” The packaging may be especially designed to improve on current produce and perishable consumer package that is not, for a number of reasons, recyclable or easily recyclable. This new “naked packaging” is designed to have improved post-consumer use value, that can more easily enter the recycle stream rather than the land fill.

Perishable products are valuable and often sold by weight. Sizes of perishable produce/products may vary throughout the production cycle requiring multiple package sizes and changes throughout the harvest cycle or season. This may result in product packs that look partially filled although the target weight may be obtained. According to embodiments, bottom inserts may provide benefits such as protecting the product, cushioning, improve cooling, and be combined with other Functional Packaging to provide a more flexible and better outcome than prior art. This is especially the case when combined with other features within the instant disclosure. Embodiments of such inserts are described herein.

According to an embodiment, the packaging may include various inserts to quickly, easily, efficiently, and cost effectively i) manage volume and/or weight, ii) improve produce cooling, venting, and/or airflow, iii) control moisture loss and/or dehydration, iv) help manage product safety, v) add and/or provide individual or multiple functional treatments to the benefit of the product quality, shelf-life, safety, and/or organoleptic properties, or vi) any combination of the foregoing.

According to an embodiment, the system and method may use one or more easily removable, peelable, dissolvable, discardable, and/or degradable inserts, internal or external labels, internal or external sleeves, and sealing tapes. The labeling described herein may contain printed or applied information as may be required or useful regarding the product, company, regulatory, UPC, weight, volume, recipes, etc. The label may be printed on the packaging itself with biodegradable, recyclable, and/or environmentally friendly inks or materials that eliminate the need for separately applied labels and at the same time continue to allow for the recyclability, biodegradability, and/or composability of the package.

The labeling and/or inserts may have predetermined placement and/or predetermined design and shape elements of the label, insert, and/or packaging. The predetermined placement, design, shape, etc. of the labeling and/or inserts may use less material and/or may allow for use of a wider variety of materials to meet product, package and environmental needs. The predetermined placement, design, shape etc. of the labeling and/or inserts may allow for better product visibility within the package while meeting label and legal requirements, lower costs, faster and/or easier insertion and removal, and/or better functionality with respect to the internal labels and inserts staying in place within the packaging. The composability and/or the dispersing of the functional treatments applied thereto may be affected, improved, and/or enhanced significantly in order to achieve the desired outcome based on the specific materials, design, pattern, placement, shape, fit and compatibility between the package, the product, and the insert/label. The predetermined placement, design, shape etc. of the labeling and/or inserts may affect, enhance, and/or improve the targeted and/or programmed treatment and substance release as well as the effective prescribed dose/amounts being transferred to the benefit of the product are also factors.

According to an embodiment, after protecting, preserving, enhancing the product from production to consumer, the goal is to end up with “naked packaging” that is 100% recyclable plastic, biodegradable, compostable, or combinations thereof. The recyclable, biodegradable, and/or compostable packaging may include separate inserts, labels, sleeves, tapes or printing tied to the product packaging, each of which may also be recyclable, biodegradable, compostable, or combinations thereof. All of the packaging components may be easily and efficiently added or removed and sorted as may be appropriate either automatically or manually.

According to an embodiment, inserts may be designed to fit in the base of the consumer package and designed to be multi-dimensional in shape with variable height, width, and depth. The material construct of the insert may also vary to meet a specific and predetermined need of the package or product.

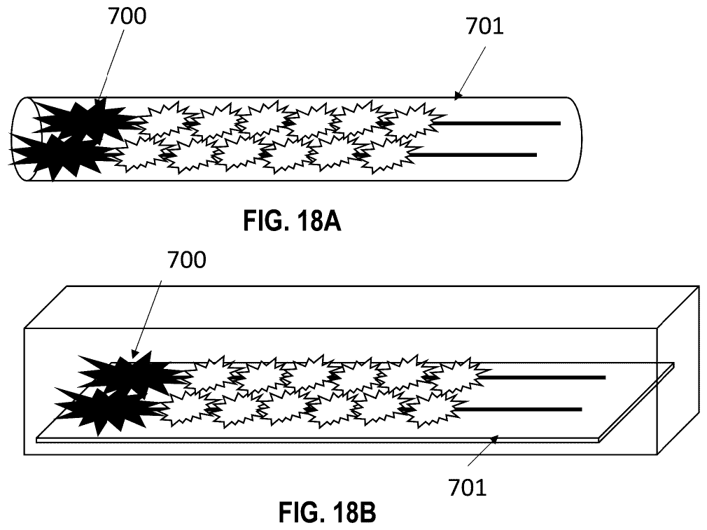

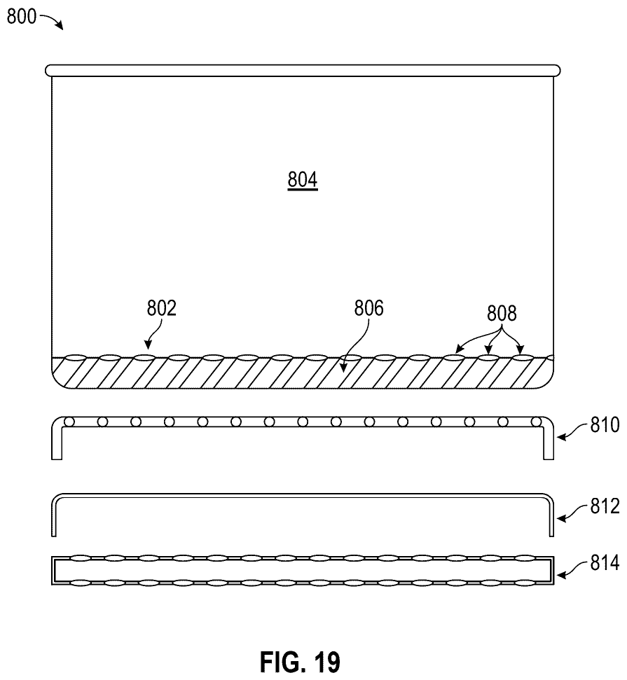

Referring to FIGS. 19 and 20, various embodiments of packaging are shown. The packaging may be a punnet, consumer packaging, a clam shell, a cup, small consumer packaging, or other known packaging. For ease of discussion, the packaging of FIGS. 19 and 20 is referred to as a punnet, although any of the aforementioned packaging may be employed.

Referring specifically to FIG. 19, a punnet 800 is shown. The punnet 800 may include an insert spacer 802. The insert spacer 802 may allow for an adjustable volume within the interior 804 of the punnet 800. The insert spacer 802 may allow for control of product filling the interior 804 of the punnet 800. The insert spacer 802 may allow for control of the volume and/or weight of product which fills the interior 804 of the punnet 800. The punnet 800 may include a vent 806. The vent 806 may allow for flow through of treatments (e.g., the substances described herein), improved cooling of the perishable product in the interior 804 of the punnet 800, or combinations thereof. A functional treatment may be applied at 808 to the surface of the insert spacer 802. The functional treatment may be applied for immediate release, controlled release, delayed release, or combinations thereof. The functional treatment may be any of the treatments and/or substances described herein.

The insert spacer 802 of the punnet 800 may have a folding fit and may be a manual or automated insert. The insert spacer 802 may allow for volume and/or weight of product adjustment capability. The insert spacer 802 may be vented to allow for improved cooling and/or air flow through the punnet 800. The insert spacer 802 may be applied with a functional treatment that may be sprayed on, printed on, or otherwise adhered or applied to a surface of the insert spacer 802. The functional treatment may be applied to an upper surface of the insert spacer 802.

The punnet 800 may be provided without a lid prior to lidding or closing, cooling etc. The punnet 80 may be provided with any type of lid, clamshell, or closure. The punnet 800 may be provided with lidding material that complements or augments other packaging, punnet or inserts. The punnet 800 may be a standard punnet. The punnet 800 may comprise plastic, paper, pulp, compostable materials, recyclable materials, or any combination thereof.

With continued reference to FIG. 19, the punnet 800 may include a first bottom spacer 810, a second bottom spacer 812, and a third bottom spacer 814. Any combination of the spacers 810, 812, 814 may be provided with the punnet 800. The first bottom spacer 810 may be a vented bottom spacer. The first bottom spacer 810 may be a simple folded spacer and/or may be folded and locked in place with respect to the punnet 800. The second bottom spacer 812 may be a non-vented spacer. The third bottom spacer 814 may be a porous treated vented spacer combined with one or more functional treatments.

Referring specifically to FIG. 20, a punnet 900 is shown. The punnet 900 may include a surface 902. The surface 902 may be adjustable. The surface 902 may be moved vertically upward and downward with respect to the punnet 900. The surface 902 may allow for control of the interior volume and/or weight of the product provided in the punnet 900. The surface 902 may be the bottom surface of the punnet 900 and/or may be an insert. The height of the surface 902 with respect to the sidewalls of the punnet 900 may be selectively adjusted based on the product, size of the product, weight of the product, type of the product, desired occupied volume, desired final weight, desired air flow, or combinations thereof, to be provided within the punnet 900. The surface 902 may be flexible or adjustable with a machine.

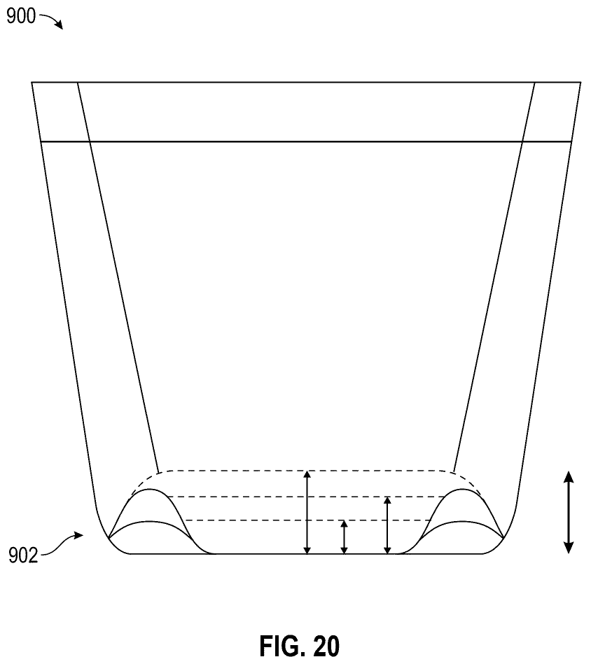

FIG. 21 shows a punnet 1000. The punnet 1000 may include a label or insert 1002. The insert 1002 is depicted in FIG. 21 in top view (1002a) not installed within the punnet 1000 and inside view (1002b) as installed in the punnet 1000. The insert 1002 may be placed in a bottom of the punnet 1000. The insert 1002 may be provided to i) control volume and/or weight, ii) enhance cooling efficiency of the product within the punnet 1000, iii) provide direct or indirect functional substance treatments, iv) include or allow for air flow channels and/or gas or treatment diffuser, or v) any combination thereof. The insert 1002 may provide turbulent air flow to enhance cooling.

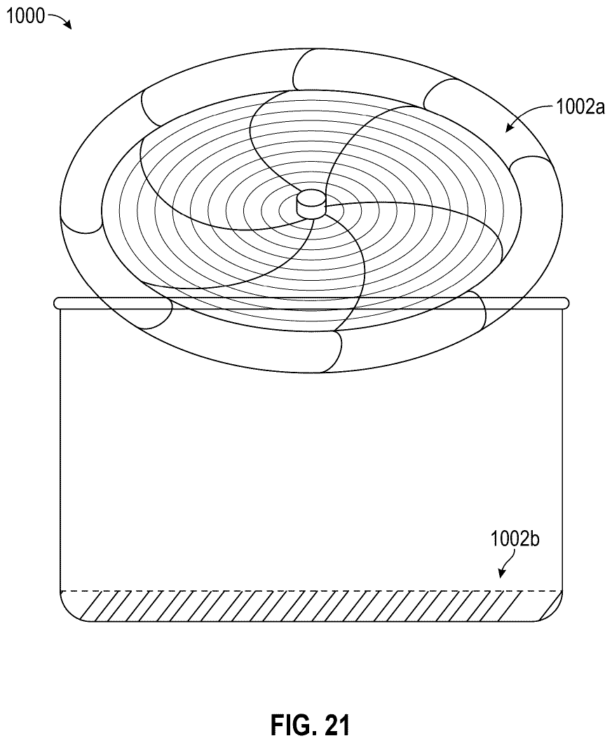

FIGS. 22A to 22E show an exemplary label or folded insert 1100. The folded insert 1100 may be provided in a package 1102, such as, for example, a clam shell. The insert 1100 may be easily removable, peelable, dissolvable, discardable, recyclable, compostable, and/or degradable. The folded insert 1100 may contain printed or applied information as may be required or useful regarding the product, company, regulatory, UPC, weight, volume, recipes, etc. The folded insert 1100 may be applied with a functional treatment, such as those described herein.

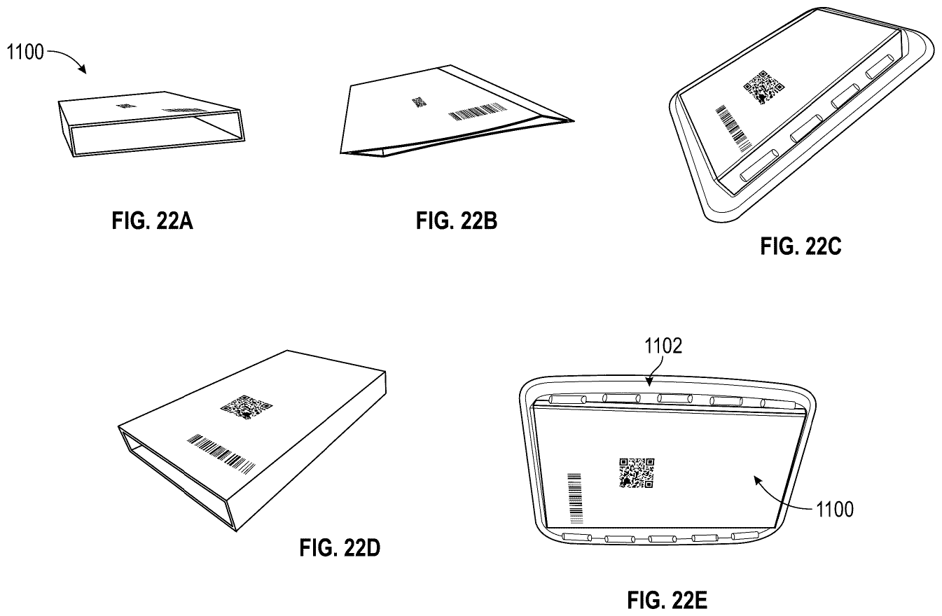

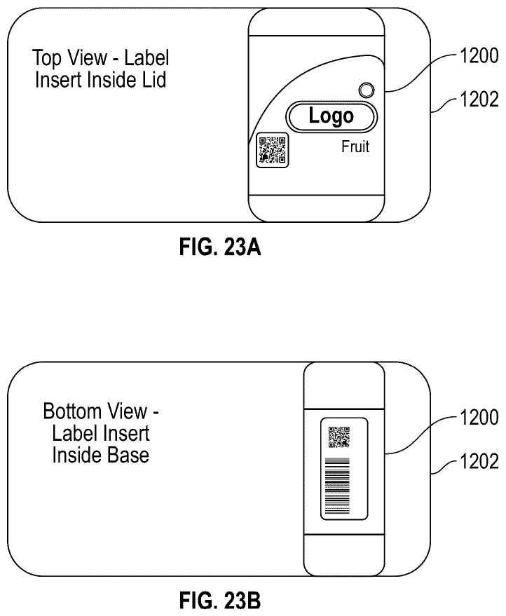

FIGS. 23A and 23B show exemplary views of an insert or label 1200 according to the present disclosure. The label 1200 may be placed inside a lid of the packaging 1202 or inside a base of the packaging 1202, or both. The label 1200 may be easily removable, peelable, dissolvable, discardable, recyclable, compostable, and/or degradable. The label 1200 may contain printed or applied information as may be required or useful regarding the product, company, regulatory, UPC, weight, volume, recipes, etc. The label 1200 may be applied with a functional treatment, such as those described herein.

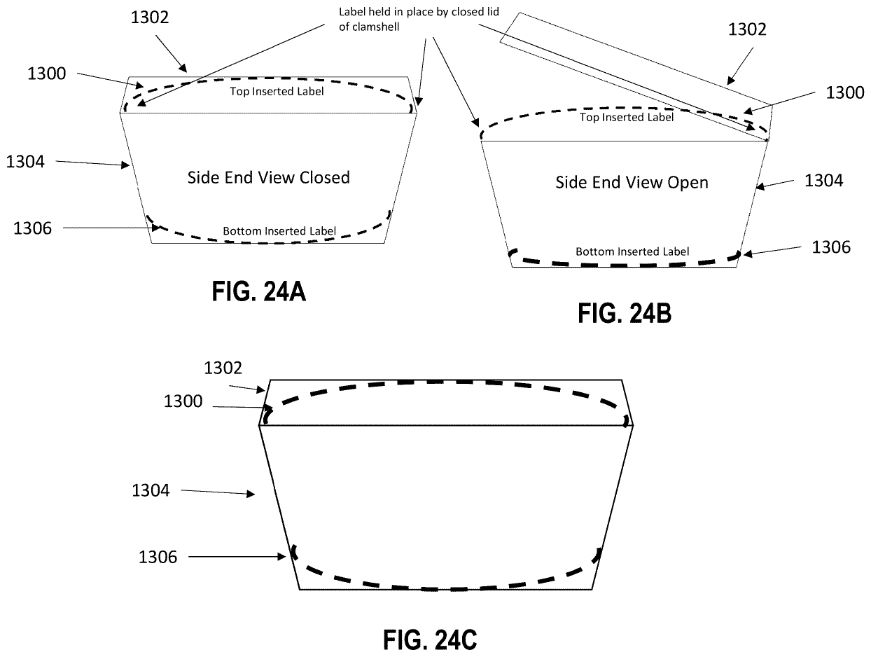

Referring to FIGS. 24A to 24C, an insert or label 1300 may be placed inside a lid 1302 of a package 1304 (such as, for example, a clam shell). The label 1300 may be held in place by the closed lid 1302 of the package 1304. A label 1306 may be placed inside a bottom of the package 1304. The label 1306 may be placed within the bottom surface of the package 1304 or within the interior of the package 1304 on top of the bottom surface of the package 1304. The label 1300 and/or label 1306 may be easily removable, peelable, dissolvable, discardable, recyclable, compostable, and/or degradable. The label 1300 and/or label 1306 may contain printed or applied information as may be required or useful regarding the product, company, regulatory, UPC, weight, volume, recipes, etc. The label 1300 and/or label 1306 may be applied with a functional treatment, such as those described herein.

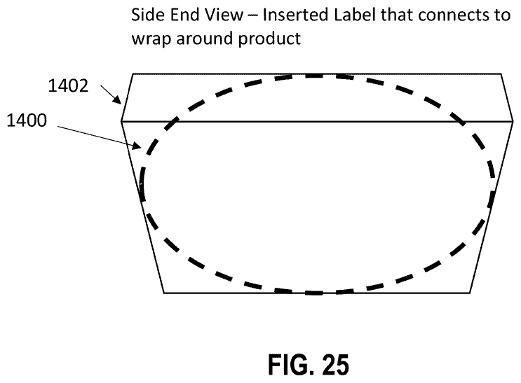

Referring to FIG. 25, an insert or label 1400 may be placed inside a package 1402. The label 1400 may be inserted such that it connects a top insert and a bottom insert to wrap around the product. The label 1400 may be a sleeve or other connected insert to surround the product. The label 1400 may be easily removable, peelable, dissolvable, discardable, recyclable, compostable, and/or degradable. The label 1400 may contain printed or applied information as may be required or useful regarding the product, company, regulatory, UPC, weight, volume, recipes, etc. The label 1400 may be applied with a functional treatment, such as those described herein.

With continued reference to FIG. 25, in addition to being held in place by encircling the product filled in the package 1402, the label 1400 or insert may connect with the top and bottom of the package 1402. This may include connecting to at least one side of the package 1402 or both sides of the package 1402. The connection to the package 1402 may allow for the label 1400 to be held in place. The label 1400 may be held in place within the package 1402 by temporary adhesives, the design of the label 1400, elements of the package shape, design, or closure, and/or the product filled into the package 1402, or combinations thereof. The label 1400 may be designed in a predetermined or desired shape, width, length, thickness, or combinations thereof and made of appropriate material to serve the desired or required purpose according to the particular packaging, product to be held in the packaging, functional treatment to be applied, or combinations thereof.

As may be appreciated, any of the foregoing packaging and/or labels may be used in combination with each other and with any of the other features (e.g., functional treatments) described herein. Any of the foregoing packaging and/or labels may be compostable, recyclable, degradable, etc. When used in conjunction, both the packaging and the label may be compostable, recyclable, or degradable such that the entire packaging is easily disposed of, recycled, or composted by the user.

It is foreseen that the aspects and features of the various embodiments described herein may be used in combination with each other.

While various exemplary embodiments have been described above, it should be understood that they have been presented by way of example only, and not limitation. Aspects of one embodiment can be used with other aspects of other embodiments of the invention in various combinations. Thus, the breadth and scope of the present disclosure should not be limited by any of the above-described exemplary embodiments.

1. A method for treating a perishable product comprising:
wet or dry washing, sanitizing, cleansing or cleaning a surface of the perishable product after harvesting of the perishable product; and
directly applying a functional treatment to contact or coat a surface of the perishable product using a carrier,
wherein the wet or dry washing does not saturate the perishable product and applies minimal additional moisture to the perishable product.

2. The method for treating the perishable product of claim 1, further comprising:
directly applying a second functional treatment to the surface of the perishable product prior to final packaging of the perishable product using a second carrier, wherein the functional treatment and the second functional treatment provide a synergistic effect to enhance a quality of the perishable product.

3. The method for treating the perishable product of claim 2, wherein the functional treatment includes a sanitizer and the second functional treatment includes a durable coating.

4. The method for treating the perishable product of claim 2, wherein the functional treatment comprises a surfactant and at least one of mineral salts or buffering agents; and the second functional treatment comprises a sanitizer.

5. (canceled)

6. (canceled)

7. The method for treating the perishable product of claim 2, further comprising directly applying a third functional treatment to the surface of the perishable product, wherein the functional treatment includes a sanitizer, the second functional treatment includes at least one of an essential oil or essence, and the third functional treatment includes an ethylene absorbing or ethylene neutralizing material.

8.-23. (canceled)

24. The method for treating the perishable product of claim 1, further comprising:
detecting contamination present on the surface of the perishable product or within an immediate environment of the perishable product; and
applying an additional amount of the functional treatment to the surface of the perishable product when the contamination is above a specified amount.

25. The method for treating the perishable product of claim 1, further comprising:
determining a dwell time of the functional treatment; and
deactivating the functional treatment when the dwell time of the functional treatment is reached.

26.-39. (canceled)

40. The method for treating the perishable product of claim 1, further comprising controlling a dwell, treatment, or exposure time and concentration of the functional treatment on the surface of the perishable product, wherein the carrier is recirculated air or industrial gas.

41. The method for treating the perishable product of claim 1, further comprising:
determining a target surface area of the perishable product;
selecting an amount of a substance to be applied to the surface of the perishable product based on the substance and the target surface area of the perishable product;
determining a treatment time of the surface of the perishable product;
determining a distance from the surface for application of the substance; and
directly applying the selected amount of the substance to the surface of the perishable product for the treatment time at the distance from the surface.

42. The method for treating the perishable product of claim 1, further comprising:
measuring an amount or effect of the functional treatment on the surface of the perishable product; and
reapplying the functional treatment when the amount or effect of the functional treatment on the surface of the perishable product is below a predetermined value.

43.-45. (canceled)

46. A system for treating a perishable product with a substance treatment comprising:
one or more devices for directed substance application to a surface of the perishable product at selected points during the process from harvest to cooling and then during filling of final packaging of the perishable product using a carrier that allow the treatment to have a predetermined effect;
a sensor for evaluating the surface of the perishable product; and
a controller for controlling the directed substance application based on feedback from the sensor.

47. (canceled)

48. The system of claim 46, further comprising:
a treatment area having a perishable product inlet, the treatment area including at least one treatment device configured for direct application of a substance to the perishable product and a device for coating the perishable product;
a conveyor passing through the treatment area configured to transport the perishable product; and
a packaging area configured to receive the perishable product from the treatment area, the packaging area including a container to package the perishable product.

49. The system of claim 46, further comprising sensors that measure an amount of the directed substance applied to the surface of the perishable product, wherein the controller uses a feedback loop for adjusting the amount of the directed substance applied to subsequent perishable products based on the amount of the directed substance measured.

50. The system of claim 46, wherein the controller receives data comprising at least one of environmental conditions, airborne fungal spore count, decay levels, pest count, soil quality, water conditions, crop conditions, mineral deficiencies, and growing conditions of the perishable product, and the controller applies predictive artificial intelligence and machine learning to the received data to determine the directed substance for application.

51. (canceled)

52. (canceled)

53. The system of claim 46, further comprising a meter for controlling an amount of the directed substance applied to the perishable product, wherein the sensor detects an area on the surface of the perishable product prone to decay or contamination and the amount of the surface of the perishable product that is covered by the directed substance, and wherein the controller meters the amount of the directed substance applied to the perishable product based on feedback from the sensor.

54. A method for treating a perishable product comprising:
incorporating a functional ingredient onto a surface of a packaging material; and
packing the perishable product into or with the packaging material,
wherein the functional ingredient transfers from the packaging material to the surface of the perishable product or wherein the functional ingredient does not transfer from the packaging material to the surface of the perishable product.

55. The method for treating the perishable product of claim 54, wherein the functional ingredient neutralizes, absorbs or blocks ethylene; absorbs or neutralizes malodors; absorbs or neutralizes carbon dioxide; or sanitizes.

56. The method for treating the perishable product of claim 54, wherein the packaging material is an insert or a label with functional properties.

57. The method for treating the perishable product of claim 56, wherein the insert is an adjustable insert configured to change an interior volume of a package surrounding the perishable product.

58. The method for treating the perishable product of claim 57, wherein the adjustable insert comprises venting configured to improve cooling of the perishable product in the package.

59.-66. (canceled)
